(19) United States
(12) Patent Application Publication
(10) Pub. No.: US 2024/0160903 A1
(43) Pub. Date: May 16, 2024

(54) ARTIFICIAL INTELLIGENCE AGENT SYSTEMS AND METHODS OF USE

(71) Applicant: Aptima, Inc., Woburn, MA (US)

(72) Inventors: Adam Fouse, Medford, MA (US); Ryan Mullins, Somerville, MA (US); Patrick Cummings, Reading, MA (US); Manuel Moquete, Methuen, MA (US); Nathan Schurr, Poway, CA (US); John Feeney, Beavercreek, OH (US); Chad Weiss, Beavercreek, OH (US)

(73) Assignee: Aptima, Inc., Woburn, MA (US)

(21) Appl. No.: 18/450,277

(22) Filed: Aug. 15, 2023

Related U.S. Application Data
(63) Continuation-in-part of application No. 17/374,974, filed on Jul. 13, 2021.
Application No. 17/374,974 is a continuation-in-part of application No. 17/143,152, filed on Jan. 6, 2021.
Application No. 17/143,152 is a continuation-in-part of application No. 17/000,327, filed on Aug. 23, 2020, now abandoned.
(60) Provisional application No. 63/371,404, filed on Aug. 15, 2022.
(60) Provisional application No. 63/051,305, filed on Jul. 13, 2020.
(60) Provisional application No. 62/985,123, filed on Mar. 4, 2020.
(60) Provisional application No. 62/916,077, filed on Oct. 16, 2019.

(51) Int. Cl. G06N 3/0475

(52) U.S. Cl. CPC G06N 3/0475

(57) ABSTRACT

Disclosed are systems and methods of communicating an attribute of an artificial intelligence (AI) agent system through an interface. The methods comprise receiving input data, determining attribute values of attributes to the input data over temporal periods, determining interface attribute values representing the interface attributes and communicating the interface attribute values to a dynamic interface. Also disclosed is a contextualized system comprising a contextualizer module and a user interface configured to communicate a recommended data to a user. In some embodiments, the contextualizer module selects a most pertinent data as the recommended data based on an activity of the user.

### CROSS-REFERENCE TO RELATED APPLICATIONS

This application claims benefit of U.S. Pat. App. No. 63/371,404, filed on Aug. 15, 2023; this application is a Continuation in Part application of U.S. patent application Ser. No. 17/374,974, filed on Jul. 13, 2023; this application is a Continuation in Part application of U.S. patent application Ser. No. 17/143,152, filed on Jan. 6, 2021; this application is a Continuation in Part application of U.S. patent application Ser. No. 17/000,327, filed on Aug. 23, 2020; U.S. patent application Ser. No. 17/374,974 claims benefit of U.S. Pat. App. No. 63/051,305, filed on Jul. 13, 2020; U.S. patent application Ser. No. 17/143,152 claims benefit of U.S. Pat. App. No. 62/985,123, filed on Mar. 4, 2020; U.S. patent application Ser. No. 17/000,327 claims benefit of U.S. Pat. App. No. 62/916,077, filed on Oct. 16, 2019; and the entire contents of all are hereby incorporated by reference.

### STATEMENT REGARDING FEDERALLY SPONSORED RESEARCH OR DEVELOPMENT

This invention was made with Government support under Contract No. FA8650-18-C-6869 awarded by the U.S. Air Force and FA8650-19-P-6002 awarded by USAF, AFMC, AFRL Wright Research Site. The Government has certain rights in the invention.

### REFERENCE TO SEQUENCE LISTING, A TABLE, OR A COMPUTER PROGRAM LISTING COMPACT DISC APPENDIX

Not applicable.

### BACKGROUND OF THE INVENTION

### 1. Field of the Invention

This invention relates to artificial intelligence (AI), in particular AI based agents and methods of using them.

### 2. Background

AI agents are digitally instantiated entities in complex systems that specifically sense their environment, exhibit attributes, adopt behaviors, and perform actions towards goals as determined by their underlying models. Such models may be deterministic or probabilistic. AI agents require sensors (to collect data) and actuators (to affect the world).

Interactive AI agents (or simply Interactive Agents [IA]) are a class of AI agents that directly or indirectly interface with one or more human users of the agent or the larger system in which they exist. At a basic level, IA both ingest human-sourced sensing data to inform the models driving them and output data in the form of human-destined communication, using one or more modalities (such as visual, aural, touch-based, smell-based, or taste-based).

Conversational agents (CAs) are a class of Interactive Agents that use natural language as their primary interface with humans as part of a sociotechnical system. The nature of their use influences the design of the underlying artificial intelligence and their embodiment. To date, CAs have been applied in three relevant use cases:
Question-Answering. Some CAs support information retrieval given a question posed in natural language via a text- or speech-based interface. Modern context modeling has enabled evolutions in chatbot interactions, from a disjointed question-answer responses to iterative refinement of a shared context enabling more accurate and precise information retrieval. This subclass of CA has shown longitudinal utility in a variety of service-oriented tasks.
Debate. CAs have started to participate in debates against humans. Debate is a highly structured discourse where opponents must recognize an argument and present an optimal counter-argument in order to “win”. CA debaters rely on corpora of existing arguments, which they assess in real-time for quality and relevance, to perform in these conditions.
Ideation. CAs have been used in ideation—the process of by which ideas are developed, cultivated, and actualized—as supporting tools, such as a discussion moderator, a facilitator, or a planner. Their use is restricted to these roles due to the limited ability of AI to synthesize novel, veridical concepts from previously established facts.

Humans interacting in conversations use various forms of information to establish and maintain context. This information not only includes the utterances during the conversation, but also includes but is not limited to, the topic of the conversation, any materials that were provided prior to the conversation (e.g. read ahead materials, presentation slides, assigned readings, etc.), memories of prior conversations, knowledge of other participants in the conversation, participants' position (e.g., subordinate, peer, superior, etc.), participants' roles in the conversation (e.g., facilitator, subject matter expert, novice, unknown, etc.), the participants' previously known positions on the conversation's topic (e.g., pro, anti, neutral, etc.), and any indicators of a participants' emotional state, (body language, facial expressions, speech volume, speech speed, inflections, emphasis, etc.). For CAs to effectively participate in a conversation and communicate with their human counterparts they also need to establish and maintain context in terms of the conversation.

### BRIEF SUMMARY OF THE INVENTION

The following summary is included only to introduce some concepts discussed in the Detailed Description below. This summary is not comprehensive and is not intended to delineate the scope of protectable subject matter, which is set forth by the claims presented at the end.

### Artificial Intelligence (AI) Agent Systems

In one example embodiment, a processor based method of having an artificial intelligence (AI) agent system contribute one or more utterance to a current discussion is provided, the method comprising collecting information about a current discussion, generating one or more potential statement for the AI agent system, constructing one or more utterance from the one or more potential statements, and communicating the one or more utterance through a user interface.

In one example embodiment, an artificial intelligence (AI) agent system for participating in a current discussion, the AI agent system comprising one or more processors, and one or more memory elements including instructions that, when executed, cause the one or more processors to perform operations comprising: collecting information about a current discussion. generating one or more potential statement for the AI agent system, constructing one or more utterance from the one or more potential statements, and communicating the one or more utterance through a user interface.

In one example embodiment, a processor-based method of communicating an attribute of an artificial intelligence agent system through an interface is provided, the method comprising receiving an input data at an agent subsystem, determining a first attribute value of a response attribute of an artificial intelligence agent system for a first temporal period given the input data, determining a second attribute value of the attribute of the artificial intelligence agent system for a second temporal period given the input data, determining a first interface attribute value of an interface attribute representing the first attribute value, determining a second interface attribute value of the interface attribute representing the second attribute value wherein the second attribute value is a different value than the first attribute value, and communicating the first interface attribute value and the second interface attribute value to the interface wherein the interface is a dynamic interface.

In one example embodiment, a processor-based method of determining an attribute value from a dialog input to an artificial intelligence agent system is provided, the method comprising receiving a dialog input data, associating a dialog input data value for the dialog input data with one or more attribute value of an attribute of the artificial agent system, determining a dialog fit between the input data value and the one or more attribute value of the dialog input data, and selecting the one of the one or more attribute value that optimizes dialog fit as the attribute value.

In some embodiments, the dialog input data comprises a dialog data type selected from the group comprising a text data, an audio data and a visual data.

In some embodiments, the attribute represents a state of the agent subsystem or a response of the agent subsystem.

In some embodiments, the interface attribute comprises a perceptual attribute, a sociotechnical attribute, a presential attribute or one selected from the group consisting of a text attribute, a shape attribute, a size attribute, a color attribute, a motion attribute, a texture attribute, a space attribute, a form attribute, a sound attribute and a sensory attribute. In some embodiments, the sociotechnical attribute represents the agent subsystem as a peer to a human.

In some embodiments, the attribute engine is configured to perform the method of determining a first and second input data value from the input data, populating an attribution algorithm with the first and second input data value, determining the first and second attribute value with the attribution algorithm and communicating the first and second attribute value to the interface engine.

In some embodiments, the interface engine is configured to perform the method of receiving the first and second attribute value, populating an interfacing algorithm with the first and second attribute value, determining the first and second interface attribute value with the interfacing algorithm and communicating the first and second interface attribute value to the output interface.

### Contextualized Systems

The disclosed contextualized components, alone or implemented in and AI agent system, all also called contextualized systems, combine interaction information, such as a dialog, with context reasoning to enhance the capabilities of artificial intelligence agent systems. The interactions may take advantage of cognitive principles and recent advances in interaction technology to improve the capabilities of artificial intelligence agent systems. The contextual information may place input information in better context for leveraging by the AI agent system or the contextual information may be used to define attributes used by the output interface.

The contextualized systems may be implemented alone or in various systems such as AI agent systems. Using an example of a data analyst using a human machine system in intelligence analysis, the context reasoning processes computational representations of context (including mission data, related intelligence, and user interactions) may be used to proactively support the analyst with partially automated product generation and recommendations of relevant information and information products. This enables analysts to more effectively process an ever-increasing amount of data.

Contextualized systems may quantify and maintain links between data from processing to dissemination. Unlike current static work products, work products generated with contextualized systems may be dynamic and interactive, enabling work product consumers to quickly access the information they need, when they need it. The dynamic nature of these products means that additional contextual information is available on-demand.

In one embodiment, a contextualized system is provided comprising: a context platform configured to receive an input data; the context platform configured to define, from the input data, a first property value of a first node corresponding to a multi-layer knowledge graph; the context platform configured to define a second property value of a second node of the multi-layer knowledge graph; the first node and the second node comprising a node pairing; the context platform defining a relationship property value of a relationship type between the first node and the second node; and a recommendation engine configured to execute a recommendation algorithm to automatically determine a context-aware recommendation of a third node based on a connection strength measure and a similarity measure.

In some embodiments, the recommendation algorithm comprises a graph traversal algorithm configured to: (a) identify one or more additional node pairing of the first node connected by any relationship type to another node in a graph layer of the multi-layered knowledge graph; (b) calculate a connection strength measure of the relationship type for each node pairing and associate the connection strength measure to each of the nodes in the node pairing; (c) calculate a similarity measure of the nodes in each node pairing and associate the similarity measure to each of the nodes in the node pairing; (d) iterate steps (a)-(c) for a next step out of the graph layer for subsequent node pairs of nodes connected by any relationships type until a threshold traversal depth of steps; (e) define each of the nodes in the each of the node pairings and the subsequent node pairings as a plurality of related nodes; (f) filter the plurality of related nodes to define a plurality of filtered nodes as a plurality of potential recommendations; (g) determine a weighted value of each of the plurality of filtered nodes as a function of the connection strength measure and the similarity measure; and (h) select the filtered activity node with the greatest weighted value as the context-aware recommendation.

In some embodiments, the first and the second node are selected from the group consisting of an activity node, a content node, an actor node and mission node.

In some embodiments, the input data comprises a chat message. In some embodiments, the input data comprises a representation of a user activity with a user interface.

In some embodiments, the first and the second node are selected from the group consisting of an activity node, a content node, an actor node and mission node.

In some embodiments, the contextualized system further comprises a synonymy layer configured to translate the input data to match the first property value and the second property value as defined by a pre-defined domain model.

In some embodiments, a processor-based method of automatically determining a context-aware recommendation to a user of a human-machine system is provided, the method comprising: receiving an input data; defining, from the input data, an activity property value of an activity node corresponding to a multi-layer knowledge graph; defining a content property value of a content node of the multi-layer knowledge graph; defining a relationship property value of a relationship type between the content node and the activity node; and executing a recommendation algorithm to automatically determine a context-aware recommendation for a second activity node or a second content node based on a connection strength measure and a similarity measure.

Other objects, features, and advantages of the techniques disclosed in this specification will become more apparent from the following detailed description of embodiments in conjunction with the accompanying drawings.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows an overview of one example embodiment of an AI agent system;

FIG. 2 illustrates an example embodiment of a process model for operating an AI agent system;

FIG. 3A illustrates in more detail an overview of one example embodiment of an AI agent system and its system components;

FIG. 3B illustrates in more detail one example embodiment of an attribute engine in an AI agent system;

FIG. 3C illustrates in more detail one example embodiment of an interface engine in an AI agent system;

FIGS. 3D-3G illustrate examples of various visual renditions of state provided by and implemented in an AI agent system, including idle (FIG. 3D), thinking (FIG. 3E), speaking (FIG. 3F), and ready to interject (FIG. 3G);

FIG. 4A illustrates example methods of determining agent attributes and agent attribute values;

FIG. 4B illustrates example methods of determining interface attributes and interface attribute values;

5 shows a process diagram illustrating one example embodiment methods of using components of the contextualized system;

FIG. 6 illustrates components of context represented as interrelated, multi-layered graphs;

FIG. 7 illustrates one example embodiment of a contextualizer module suitable for an AI agent system;

FIG. 8 illustrates one example embodiment of an initialization module of a contextualizer module suitable for an AI agent system;

FIG. 9 illustrates one example embodiment of a real-time maintenance module of a contextualizer module suitable for an AI agent system;

FIG. 10 illustrates one example embodiment of a conclusion module of a contextualizer module suitable for an AI agent system;

FIG. 11A a process flow chart of an example embodiment of the recommendation algorithm;

FIG. 11B shows an example embodiment of the recommendation algorithm in pseudo-code;

FIG. 12 shows a computer system suitable for suitable with an AI agent system; and

FIG. 13 shows a system diagram illustrating one example embodiment of a functional estimator subsystem.

### DETAILED DESCRIPTION OF THE INVENTION

COPYRIGHT NOTICE: A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to any software and data as described below and in the drawings hereto: Copyright© 2020-2023, Aptima, Inc, All Rights Reserved.

AI agent systems and methods of use will now be described in detail with reference to the accompanying drawings. Notwithstanding the specific example embodiments set forth below, all such variations and modifications that would be envisioned by one of ordinary skill in the art are intended to fall within the scope of this disclosure. For example only, and not for limitation, although example embodiments include use of the disclosed systems and methods with AI agent and contextualized systems in the course of dialog, they may also be used with other input or interaction information and output or recommendation types.

As used herein, the term “module” refers to hardware and/or software implementing entities, and does not include a human being. The operations performed by the “module” are operations performed by the respective hardware and/or software implementations, e.g. operations that transform data representative of real things from one state to another state, and these operations do not include mental operations performed by a human being.

The terms “sensor data”, as used herein is a broad term and is to be given its ordinary and customary meaning to a person of ordinary skill in the art (and are not to be limited to a special or customized meaning), and furthermore refers without limitation to any data associated with a sensor, such as a continuous analyte sensor.

### The Technical Problem

Recent advances in AI—specifically the advent of transformer-based generative language models exemplified by OpenAI's GPT-2—have resulted in capabilities that can generate believable, if not strictly veridical, statements, allowing the model to support a broad range of improvisational discourses as a peer to humans.

However, there exists no process for operating generative models as peers in a sociotechnical system, nor definitions of the methods necessary to effectively enable interaction between an AI agent system leveraging such models and human participants.

Specific problems include gaps in technology and methods to:
Capture and collate accurately statements and utterances from multiple participants, particularly when communications temporally overlap;
Adequately contextualize input data received from multiple participants in a conversation such that the sensed context effectively informs the AI agent system;
The adequately contextualize input data is used to establish context and maintain the changes of context during the conversation such that the AI agent system is effectively informed. Additionally, the AI agent system has access to other sources of contextualized data that may or may not be unavailable to human participants such as physiological data (heartrate, respiration, galvanic skin response, temperature, eye tracking measures, etc.), behavioral data (assigned tasking, tasking being performed, motion, orientation (prone, upright, angle), relative orientation to others in the conversation, and location data (latitude, longitude, in person, remote, telephone, video conference, etc.).
Assess and ensure the relevance and quality of statements and utterances generated by an AI agent system at-scale and at-speed prior to the dialog action;
Select and aggregate the relevant dimensions and features (generally defined as attributes) over which an AI agent system reasons to fit in the conversation;
Assess and ensure the coherence of the content and form (generally defined as attribute value) of the statements and utterances of an AI agent system; and
Embody or represent an AI agent system such that it achieves peer-level recognition from users.

Therefore, of specific interest is a process for operating a generative language model in multi-participant, improvisational, conjecture-based discourse providing:
Methods for collecting, collating, and contextualizing input from discourse participants in real-time;
Methods for selecting and aggregating individual statements produced by the AI into coherent utterances;
Methods for ensuring the relevance and quality of the utterances prior to the dialog action; and
Methods for embodying the AI such that it achieves peer-level recognition from humans.

### The Technical Solution

The disclosed AI agent system addresses several of these technical problems and improves the function of AI agent systems, in particular those system involved in active discourse with participants.

To understand a multi-party discourse and automatically provide a relevant response to the discourse, the disclosed AI agent system receives and processes multi-entity discourse data, applies response attribute algorithms to automatically provide a relevant response from the AI agent system. While the response is being generated, state attribution algorithms are applied to the discourse data to determine state attribute values and these values are communicated to a dynamic user interface to represent the state of the AI agent system.

Input data is received from sensors and this input is multiplexed and labeled dynamically into a single input data stream for analysis. The response and state attributes are quantified by applying reinforcement learning algorithms to identify attributes and attribute values from predetermined attribute and attribute values given the input/state data in the input data stream.

The disclosed system also improves AI agent systems by incorporating contextual information to inform the system when determining input data and when providing output to the output interface. Context-aware reasoning is provided by the use of multi-layer knowledge graphs and pattern recognition techniques across these graphs. By representing different attributes as different knowledge graphs, relationships between different attributes, such as contextual relationships, can be defined and more easily found and used to inform the AI agent system. The contextual information may be able to place input data, such as participants' statements and utterances, in better context for leveraging by the AI agent system and the contextual information may be used to define attributes used by the output interface.

The multi-layer knowledge graphs are used to establish connections between input data or interaction information such as participants, participants' attributes, participants' utterances, and conversations' attributes. For example, once captured, attributes regarding the participants' utterances, their affective state, their actions, and any prior utterances, affective state, and actions are represented by multiple knowledge graphs connected by common nodes.

A conversation can be represented as a single knowledge graph with connections containing participant utterances spoken over time—a sequence of utterances each with attributes such as who spoke the utterance, the time of the utterance, and the context of the utterance. Simple attributes about the participant may be available such as attributes about the speaker—their position in the conversation (moderator, facilitator, participant), their role in the organization, their background (education, experience, etc.). However, a conversation constructed as a connected set of knowledge graphs provides a connection of each utterance to knowledge graphs of the participant vs. simply attributes of the participant.

Representing a participant as a knowledge graph allows complex relationships to be constructed over the course of the conversation. With the relationships represented as a set of interconnected knowledge graphs, the contextualizer module can use methods such as pattern recognition techniques to identify relationships between different attributes, such as contextual relationships, to recommend information such as context information or work product to inform the AI agent system.

To assess and ensure the relevance and quality of statements and utterances generated by an AI agent system at-scale and at-speed prior to the dialog action, the technical solution disclosed employs a series of generative language (GL) models relying on the dual actionable data consisting in detected statements or utterances and the contextualized meta-data tagged to them. The GL models use the context provided by the current conversation to generate potential statements for the AI agent system. The GL models provide statements in multiple styles, for different components of a response or for different stages of a conversation.

To select and aggregate the relevant attributes over which an AI agent system reasons to provide utterances as responses to fit in the conversation, the technical solution employs a probabilistic and iterative method to score the relevance of various attributes in determining the content and form of the AI agent system's contribution to the conversation. The solution reviews a list of pre-determined attributes and assesses their relevance against the content and context embedded in the actionable data from the conversation. Attributes are then ranked based on a multifactorial score and a subset is selected based on one or more criteria.

To assess and ensure the coherence of the content and form, generally defined as attribute values, of the statements and utterances of an AI agent system, the technical solution employs a probabilistic and iterative method to score the relevance of various candidate attribute values in determining the coherence and fit of the AI agent system's contribution to the conversation. The solution constructs utterances (content) from one or more generated statements. This provides both a filter to eliminate unwanted candidate statements, and an opportunity to use the most relevant statement in each utterance. The solution also constructs multimodal communications (form) to embody the utterances to be shared with human participants.

The disclosed AI agent system achieves peer-level recognition from users by providing an interface to function as a gateway, or interface, from the language model to the other participants involved in the conversation. That gateway visually depicts the current state of the agent (thinking, speaking, idle, ready to interject) as a proxy for body language and other non-verbal communication, as well as a text-to-speech capability so that the agent can contribute utterances to the conversation.

### Difference of Technical Solution from Conventional Solutions

The disclosed AI agent system is different from conventional solutions.

Regarding input collection, the disclosed system collects input from multiple sources, such as multiple participants (be they human or even AI) in real-time, whereas prior work has collected utterances from a single human participant.

Regarding input contextualization, the disclosed system contextualizes input from participants within the scope of the discourse as relevant background to incorporate into an utterance or as a direct prompt for an utterance, whereas prior work has treated all utterances as direct prompts or revisions to direct prompts.

Regarding utterance construction, the disclosed system enables utterance construction from discrete statements generated by multiple models, whereas prior work has only leveraged a single model designed for information retrieval, not generation.

Regarding attribute selection, the disclosed system dynamically and contextually optimizes its reasoning over multiple dimensions, where prior work has employed limited (sometimes single) and static attributes.

Regarding attribute value selection, the disclosed system provides a real-time, on-the-loop quality assessment and feedback for novel utterances, whereas prior work has assessed congruence of factual information relative to the request.

Regarding output embodiment, the disclosed system achieves conversational fit and peer-level recognition from humans because it:
Places the AI in a physically similar stature to the human participants, whereas prior work has embodied the AI in a diminutive stature.
Uses distinct, multi-modal, multi-faceted representations of the AI's internal state that parallels human internal state representations, whereas prior work represents at most three states (idle, taking input, working) using a single modality (typically visual).

The AI conversational agent system is not a conventional solution.

Regarding input collection and contextualization this process:
Leverages the entire conversation history and connected knowledge graphs in order to maintain an understanding of the conversation at hand. At the same time, statement generations are most effected by the recent conversation. This enables responses to use context from the entire discussion while keeping responses relevant to the most recent utterances.
Utilizes a conversational structure between the participants and the self on model inputs. This provides context to an otherwise contextless model in order to delineate between topics being discussed and the prompt to answer. The resulting utterances therefore do not continue thoughts; rather they generate new ones as directed by the use of self.

Regarding attribute and attribute value selection, this process:
Leverages multiple models with different training corpora and parameters (domain, technical detail, etc.) to provide dynamism throughout the improvisation, which is required to enable effective performance in an unstructured or semi-structured discourse.
Provides a real-time, on-the-loop quality assessment and feedback for novel utterances, whereas prior work has assessed congruence of factual information relative to the request.

Regarding output embodiment, this process achieves peer-level recognition of the AI agent system from humans because it:
Places the AI in a physically similar stature to the human participants in order to achieve equal presence, which inverts the default human-computer interaction paradigm of human superiority.
Requires multi-modal representations of complex states (e.g., idle, thinking, speaking, interject) that minor qualities of a human peer, rather than the subservient qualities of a tool.

### The Practical Application of the Technical Solution

This technical solution is directed to the practical application of AI agents to interact with multiple users such as participating in conference panel discussions, moderating group brainstorms, or generating reports or other artifacts in a collaborative fashion.

Regarding input collection, the disclosed systems and methods provide a new feature to traditional speech-to-text as a sensor capability by multiplexing and labeling multiple participants into a single input stream for analysis. This integrated and labeled input stream allows the generative language model to differentiate between what other participants are discussing and what utterances it has formulated. This improves the ability of the language model to stay “on topic” while providing it the freedom to improvise and generate novel contribution to the multi-participant activity.

Regarding input contextualization, the AI agent and contextualized systems provide a new feature to augment GL models with context-aware metadata that renders them more efficient and effective. The contextualizer module traverses and extracts the connections of knowledge graphs representing the organization of various sources of contextualized input collected over the conversation in order to provide a rank ordering of the context-aware meta data. This improves the AI agent system's ability to fit with the conversational flow in a manner that provides value to the group, as opposed to being “on topic” but contributing content and form that do not move the conversation forward.

Regarding utterance construction, this AI agent system improves upon conventional utterance generation processes by involving multiple generative language models with inherently different training, and therefore performance, characteristics into a unified process. This produces two possible novel results that improve the dynamism and natural qualities of the discourse: 1) statements generated for two or more different generative language models can be constructed into a single utterance, thus creating a heterogeneous utterance; and 2) different models can be used to construct sequential utterances, thus creating a heterogeneous utterance sequence. Prior work only supports homogeneous utterances and utterance sequences.

Regarding attribute and attribute value selection, AI agent system further improves the fit of the AI agent system's contribution by dynamically optimizing the content and the form the system's contribution to maximize multi-dimensional objectives such as peerness, appropriateness, or relevance. In turn, the AI agent system becomes an adaptive and integral part of the group no matter how or where the group interactions go, as opposed to being a static tool or side element.

Regarding output construction, the AI agent system improves the efficiency in human-machine interface by inverting the default human-computer interaction paradigm of human superiority. Altogether, the AI agent system is able to: to take input from the moderator and/or other panelists as speech; generate natural language responses to questions that account for responses; vocalize the generated statements so that they can be heard by the audience; provide an embodiment on stage so that the audience and panel members are aware of its presence; and provide some indication of its internal state such as readiness to speak.

### One Example Embodiment of the AI Agent System

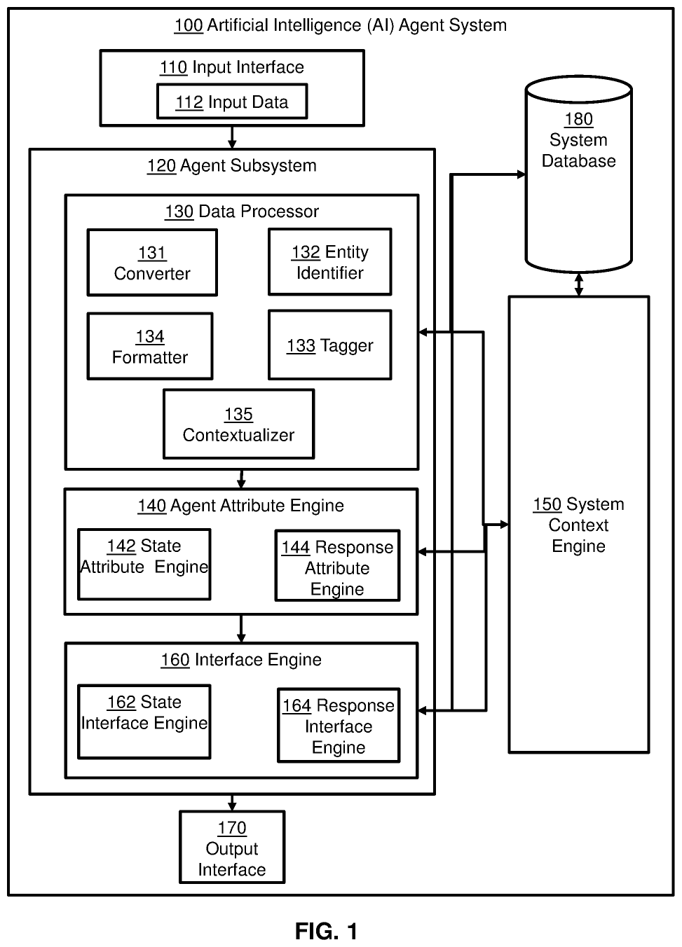

For illustration purposes and not for limitation, one example embodiment of the AI agent system is shown in FIG. 1.

The AI agent system 100 shown in FIG. 1 generally comprises an agent subsystem 120 configured to receive input data 112 from an input interface 110, such as an input sensor, and communicate additional system data to and from database 180 and an output interface 170.

The agent subsystem 120 generally comprises a data processor module 130 an agent attribute engine 140 and an interface engine 160. The data processor module 130 is generally configured to receive, process, format and communicate received input data 112 and database data the agent subsystem components such as the agent attribute engine 140. The data processor module 130 generally receives the input data 112, converts it to a digestible stream of data, tags the data and formats it for communication to the agent attribute engine 140. The data processor module 130 may also be able to identify the entity providing the input data and may be able to determine contextual information regarding the input. The agent attribute engine 140 is generally configured to receive processed input data and provide input to the interface engine 160. The agent attribute engine 140 generally defines attributes of the AI agent system where the state attribute engine 142 generally defines relevant states that the AI agent can adopt based on the input data 112 and the response attribute engine 144 generally defines the relevant responses that the AI agent can contribute based on the input data 112. The interface engine 160 generally defines how attributes are communicated through the interface where the state interface engine 162 defines how the state is communicated and the response interface engine 164 defines how the response is communicated. Both the attribute and the interface engine are the recipient of input data 112 and system data from databases 180. The agent subsystem 120 generates data transmitted to an output interface 170 for communication to and consumption by third party users (humans or AI). The input data 112 is generally used to represent current environmental state information used by algorithms in both the agent attribute engine 140 and the interface engine 160 to determine a response and other AI agent system output to the interface.

The data processor module 130 generally receives the input data 112 such as interaction or conversation data through one or more input interface 110 such as sensors or microphones. The converter 131 transforms the collected input data 112 to a digestible stream of data, for example by using a speech-to-text capability. The entity identifier module 132 dynamically identifies input data as coming from a particular entity in a multi-entity conversation. The entity identifier module 132 uses deterministic or probabilistic reasoning methods to delineate between the participants/entities for appropriately tagging of the data with relevant meta-data. The tagger module 133 dynamically applies meta-data tags to the converted data stream and the formatter module 134 formats the data for communication to the agent attribute engine 140. The tagging with meta-data allows the data to be used by one or more language models such as natural language processing (NLP) models for analysis of the actionable data or generative language (GL) models as input so they can produce new statements or utterances. The contextualizer module 135 provides context-aware reasoning to generate additional actionable data that places the participants' statements and utterances in context for analysis by the AI agent system. The contextualizer module 135 may implement methods to contextualize input data such as those methods disclosed in co-pending U.S. patent application Ser. No. 17/143,152, entitled “CONTEXTUALIZED HUMAN MACHINE SYSTEMS AND METHODS OF USE” and filed on Jan. 6, 2021, the content of which is herein incorporated by reference in its entirety. The contextualizer module 135 may also perform an NLP analysis of detected statements and utterances in the input data to assess attributes that contextualize each statement or utterance. Examples of such attributes include speed of speech, tone, emotional valence, likelihood of links to previous statements or utterances. The data processor module 130 may use a series of GL models relying on the input data attributes present in detected statements or utterances and the contextualized meta-data tagged to them.

For the disclosed solution, context is defined in a manner that takes advantage of the input provided and allows for use by the AI agent system components. In the disclosed embodiments, context may be defined as any type of information. For example, context may be about the actors, content, mission or activity associated with the system that may impact interpretation of the input date or actions to be made on the input data. With this example of four attributes, these four attributes are then treated as layers in a knowledge graph that can be analyzed using a variety of techniques. This graph-based context model can be dynamically populated by parsing input data according to a pre-defined domain model. And for system data that cannot be easily parsed with common technologies, additional tools such as a synonymy layer may be used to translate input data into domain model consistent language.

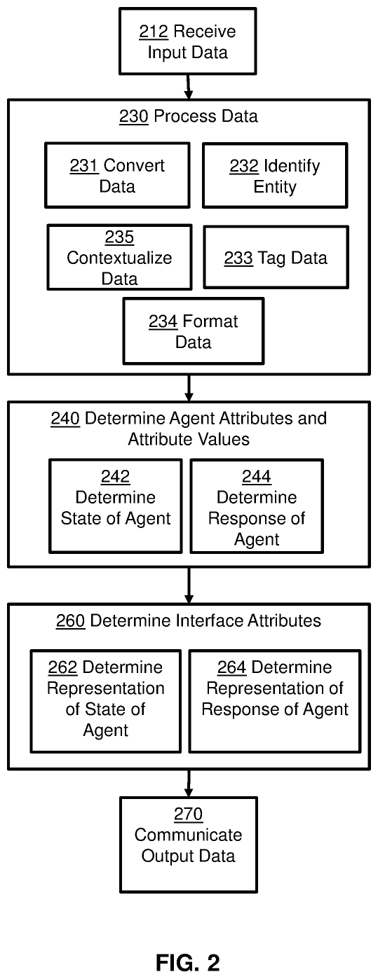

FIG. 2 illustrates methods performed by the AI agent subsystem shown in FIG. 1. The methods of FIG. 2 generally include activities that transform input data from the input interface and allow for communication of states and responses to the output interface. As shown, the AI agent system receives input data at 212. The input data is processed as 230. From these data, the AI agent system then determines agent attributes at 240 through the determination of one or more states of the agent at 242 and one or more response to be provided by the agent at 244. Then, the AI agent system determines interface attributes at 260 through the determination of one or more representations of the state of the agent at 262 and the determination of one or more representation of the response of the agent at 264. Finally, the AI agent system communicates output data to the user interface at 270.

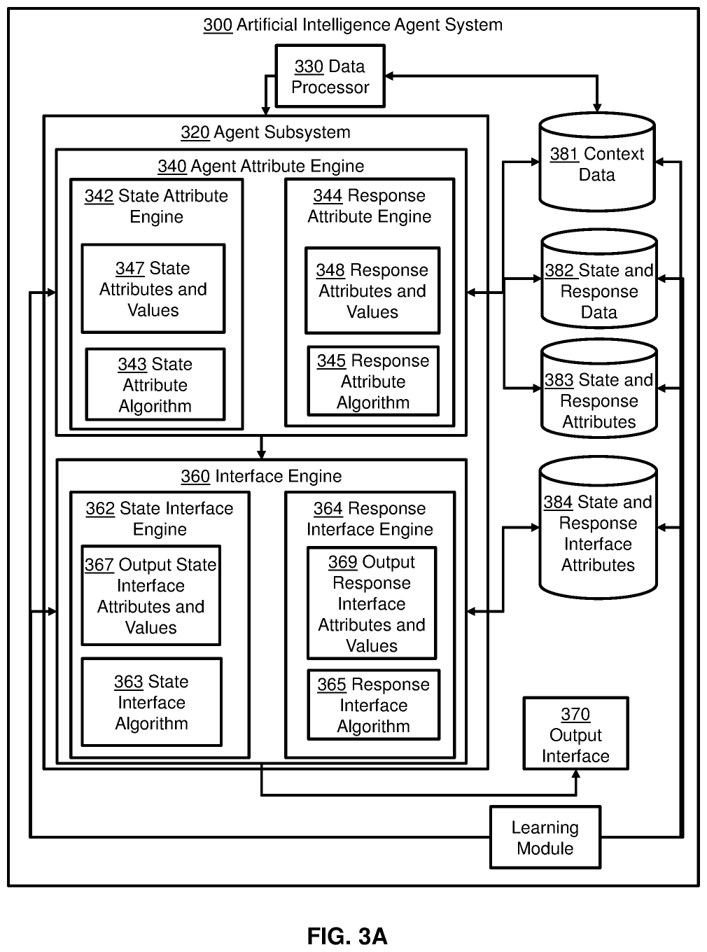

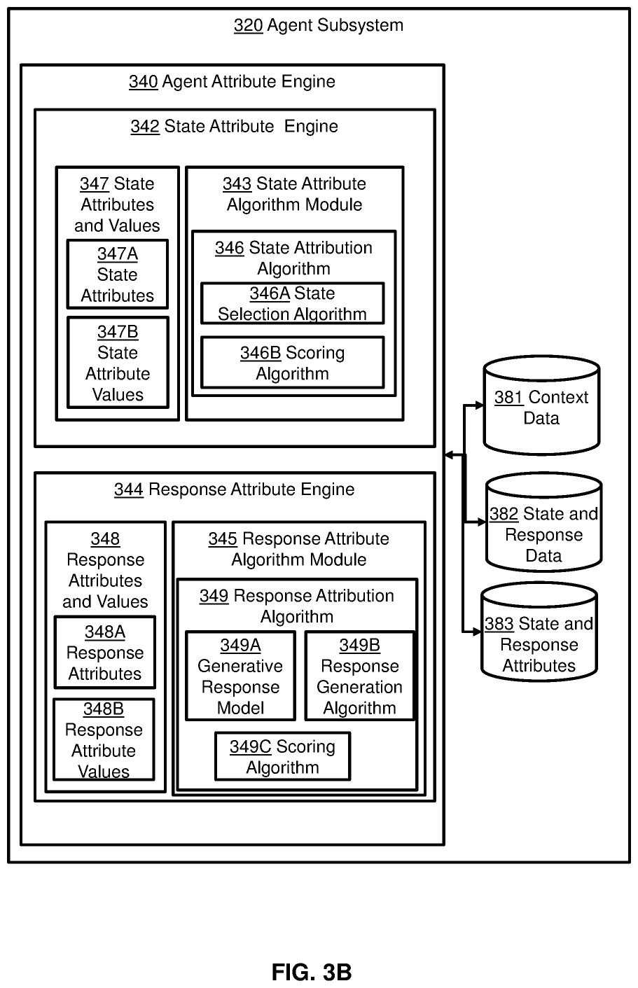

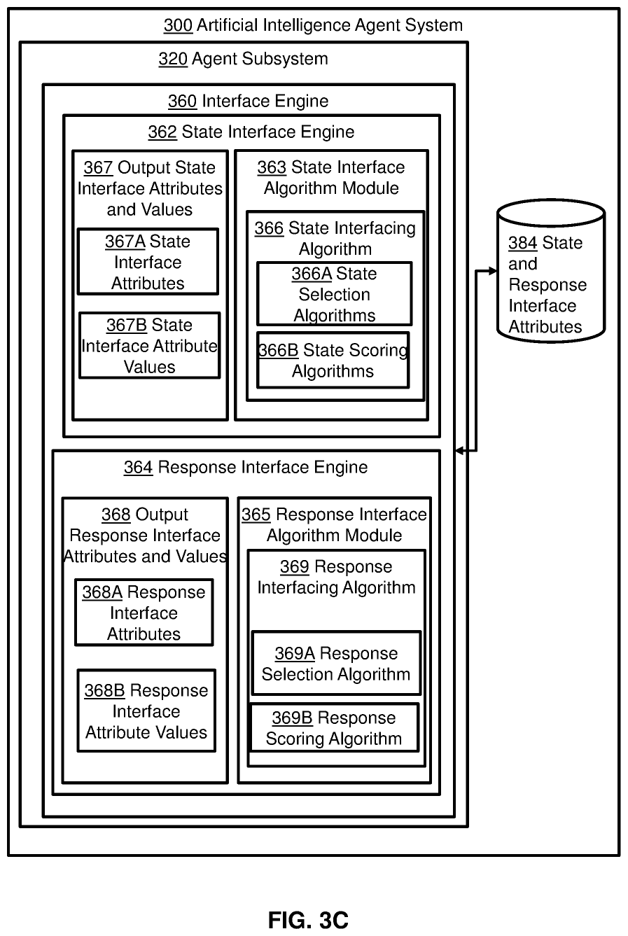

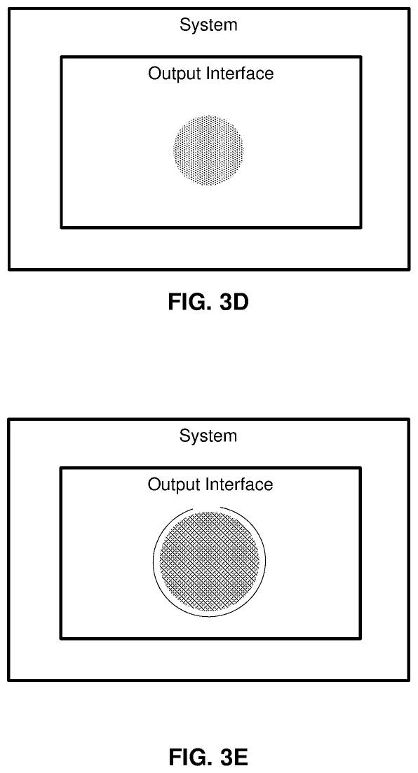

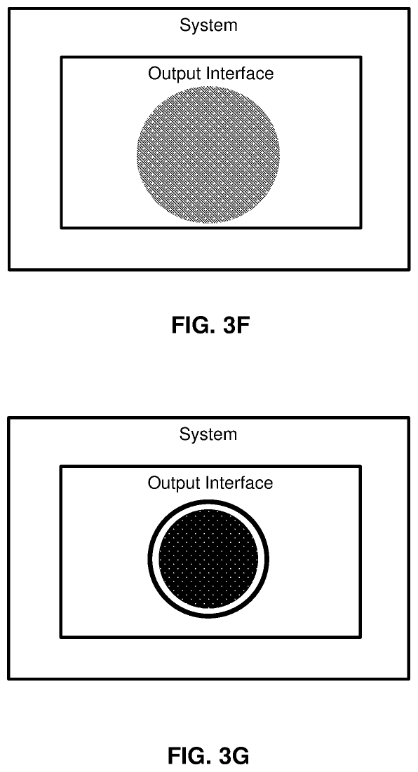

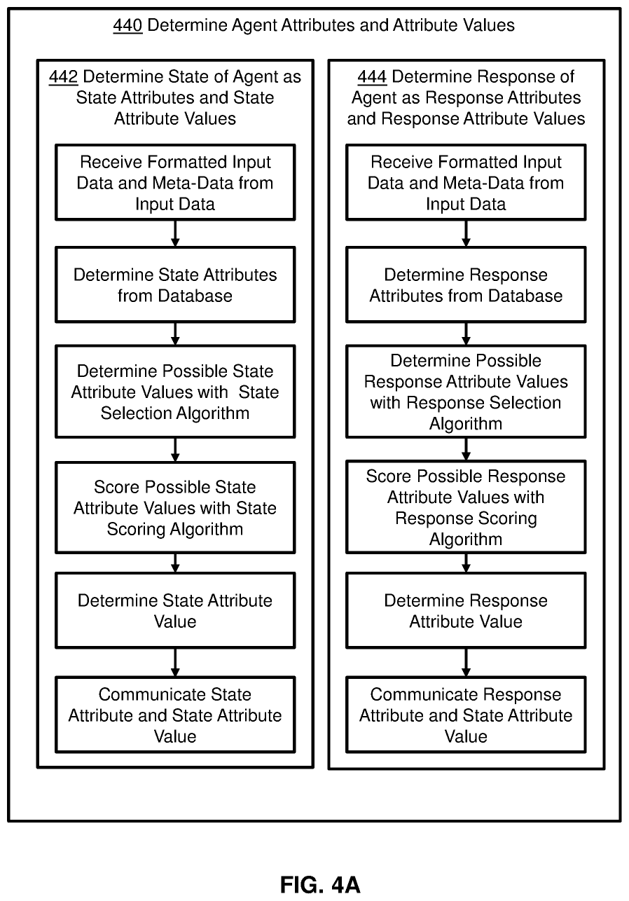

FIG. 3A shows a more detailed view of components of the AI agent system. As shown, the agent subsystem 300 receives data from the data processor 330. The agent subsystem 320 may comprise an attribute engine 340 and an interface engine 360. The state attribute engine 342 of the attribute engine 340 may further comprise state attributes and values and a state algorithm module. The response attribute engine 344 of the attribute engine 340 may further comprise response attributes and values and a response algorithm module. As also shown, the attribute engine 340 may retrieve and store data such as a context data 381, state and response data 382, state and response attributes 383.

As shown, the interface engine 360 may comprise a state interface engine 362 of the interface engine 360 may further comprise output state interface attributes and values and a state interface algorithm module 363. As also shown, the interface engine 360 may retrieve and store data such as state and response interface attribute data 384.

Generally, the output of the interface engine 360 is communicated to the output interface 370.

Within the AI agent system, reinforcement learning may be used as an algorithm to make decisions on which attributes and what values should be applied to those attributes. Through reinforcement learning, the AI agent system employs trial and error to come up with an attribute or value to the situation. The algorithm assigns either rewards or penalties for the actions the agent performs and its goal is to maximize the total reward.

The reinforcement learning algorithms may be value-based, policy-based or model-based. For a value-based method, the algorithm generally attempts to maximize a value function V(s). In this method, the agent is expecting a long-term return of the current states under policy π. For a policy-based method, which may be deterministic or stochastic, the algorithm generally attempts to come up with such a policy that the action performed in every state helps you to gain maximum reward in the future. For a model-based method, a virtual model must be created for each environment (e.g., attributes and interfaces) and the algorithm learns to perform in that specific environment.

For example, for one method, the following formula and parameters are used to define attribute values:

$$\\ {V}_{π} ( s ) = E [ R ] = E {}^{} [ {\sum }_{t = 0}^{∞} {γ}^{{}^{} t} {r}_{t} \vert {s}_{0} = s ]$$

where:
V=attribute value
s=attribute
Pi=policy function that goes from state to actions
E=expectations
R=reward
t=time
gamma=time-based discount factor
rt=reward at time t
s0=starting state

For example, for a model-based method, the virtual models may be a Markov Decision Process (MDP) model or a Q learning model. For an MDP, the following parameters are used to get a solution:
Set of actions—A (All the possible moves that the agent can take)
Set of states—S (Current situation returned by the environment)
Reward—R (An immediate return sent back from the environment to evaluate the last action)
Policy—π (The strategy that the agent employs to determine next action based on the current state)
Value—V (The expected long-term return with discount, as opposed to the short-term reward R. Vπ(s) is defined as the expected long-term return of the current state sunder policy π)

For a Q-value or action-value (Q): Q-value is similar to Value—V, except that it takes an extra parameter, the current action a. Qπ(s, a) refers to the long-term return of the current state s, taking action a under policy π.

In some embodiments, the attribution algorithm comprises a reinforcement learning algorithm to select a least one attribute value wherein the reward function comprises Rₐ(s,s′) wherein A represents a set of actions of an agent, S represents a set of an environmental state and an agent state of the agent and the reward function is defined to determine a maximum relevance of an attribute value of the agent and the attribute value with the maximum relevance defines the first interface attribute value and the second interface attribute value to the interface.

In some embodiments, the reinforcement learning algorithm comprises a Partially Observable Markov Decision Process (POMDP) and the reward function of the POMDP is defined to maximize a relevance of the attribute value wherein the attribute value defines the first interface attribute value and the second interface attribute value to the interface.

In some embodiments, the interfacing algorithm comprises a reinforcement learning algorithm to select at least one interface attribute value for the agent subsystem representing A, B, and C wherein A defines a context variable, B defines a temporal variable and C defines a desired meaning variable. In some embodiments, the reinforcement learning algorithm comprises a Partially Observable Markov Decision Process (POMDP) and the reward function of the POMDP is defined to maximize a peerness of the agent subsystem.

Generally, as used in the AI agent system, the reinforcement learning algorithms take input data representing the current state/situational data from the environment, map that current data against predefined attributes from the attribute and attribute value databases to populate the reinforced learning algorithms. The populated algorithms are then used to determine the state of the AI agent system, determine a response and determine how that response and state will be represented in the interface.

As shown in FIG. 1, a system context engine 150 may also be provided to provide the components and methods of the contextualizer module to other system components, such as the agent attribute engine 140 and the interface engine 160 to contextualize attributes and values using the contextualizer module components and methods described.

### Agent Subsystem—Attribute Engine

FIG. 3B shows more detail of an attribute engine consistent with that shown in FIG. 3A. In general, the attribute engine 340 takes input data processed through the data processor and transforms it to attributes and attribute values. The attributes may be state attributes 347A representing a state of the AI agent system or they may be response attributes 348A representing a possible response to be provided by the AI agent system. These attributes and attribute values are provided to the interface engine 360 that defines the attributes and values to be provided to the output interface 370. The state attributes and attributes values 347 come from predefined attributes and values stored in the state and response attributes database 383.

In some embodiments, the steps of determining attributes may comprise those steps disclosed in co-pending U.S. patent application Ser. No. 17/374,974, entitled “ARTIFICIAL INTELLIGENCE AGENT SYSTEMS AND METHODS OF USE” and filed on Jul. 13, 2021, the entire contents of which are incorporated herein.

Referring to FIG. 3B, the state attributes 347A of the state attribute engine 342 may comprise state attributes such as for example only and not for limitation, attributes of the AI agent state such as cognition or communication. State attribute values 347B for these attributes reflect an objective measure of these attributes. For example, and not for limitation, examples of state attribute values for the state attribute of cognition may be listening or thinking. For example, and not for limitation, examples of state attribute values for the state attribute of communication may comprise silent, paused, ready or active. The state attributes and state attribute values may include contextual data determined by the contextualization module in the data processor.

In some embodiments, the state attribute values 347B are determined by the state attribute algorithm module 343 which generally defines the attributes of the state of the AI agent system based on input data. The state attribute algorithm module 343 may comprise a state attribution algorithm 346 which may further comprise a state selection algorithm 346A and a scoring algorithm 346B. The state attribution algorithm 346 generally reviews potential combinations of state attribute values against input data and outputs the set of state attribute values that maximizes relevance. The state selection algorithm 346A generally generates the combinations of states attribute values to be reviewed, based on a database of predetermined possible values. The scoring algorithm 346B generally computes the relevance of the selected set of state attribute values against the input data and returns a relevance score to the attribution algorithm.

The response attribute engine 344 generally defines the attributes of relevant responses that the agent can contribute based on inputs. The response attribute engine 344 may comprise response attributes and values 348 and a response attribute algorithm module 345. For example only, and not for limitation, examples of response attributes 348A may include volume, type of response, content of response. For example only, and not for limitation, examples of response attribute values 348B for response attribute volume may include loud or quiet, examples of response attribute values for response attribute type may include a statement or a question, and examples of response attribute values for response attribute content may include generated utterance A, generated utterance B or generated utterance C.

In some embodiments, the possible response attributes 348A are predetermined in a database such as the state and response attributes data 383 and state and response data 382. In some embodiments, the attribute values are determined by the response attribute algorithm module 345.

The response attribute algorithm module 345 may comprise a response attribution algorithm 349 which may further comprise a response generation algorithm 349B, a generative response model 349A and a scoring algorithm 349C. The response attribution algorithm 349 generally reviews potential combinations of response attribute values against input data and outputs the set of response attribute values that maximizes relevance. The response generation algorithm 349B generally generates the combinations of response attribute values to be reviewed, based on a database of predetermined possible values (e.g., “volume” or “type”) or based on a generative response model 349A. The scoring algorithm 349C generally computes the relevance of the selected set of response attribute values against the input data and returns a relevance score to the attribution algorithm. The generative response model 349A permits the creation of new utterances.

### Agent Subsystem—Interface Engine

FIG. 3C shows more detail of an attribute engine consistent with that shown in FIG. 3A. In general, the interface engine 360 as part of the agent subsystem 320 takes (a) state attributes and values and (b) response attributes and values from the attribute engine and transforms it to attributes and attribute values for the interface. The attributes may be output state interface attributes and values 367 representing a state of the AI agent system 300 or they may be output response interface attributes and values 368 representing a response provided by the AI agent system 300. The interface engine 360 determines and defines how to represent the state attributes values considering the outputs of the attribute engine in order to maximize the “fit” of the agent's state and response (e.g., peerness, appropriateness, relevance, etc.) through the interface.

Referring to FIG. 3C, the state interface engine 362 generally determines the output state interface attributes and values 367 provided by the AI agent system. The output state interface attributes and values 367 of the state interface engine 362 may comprise state interface attributes 367A such as for example only and not for limitation may comprise interface attributes 367A of the AI agent state such as peerness, relevance, appropriateness and presence. Typically, the state interface attributes 367A are predefined in the state and response interface attribute database 384 and are selected based on the input data received. State interface attribute values 347B for these attributes reflect an objective representation of these attributes through the output interface. For example, and not for limitation, examples of state interface attribute values for the state attribute of peerness (the degree to which the AI agent system, through the output interface, shares characteristics with another participant_ may be color, size or sound volume. For example, and not for limitation, examples of state attribute values for the state attribute of presence may comprise rate of change, color, size or sound volume. Typically, the state interface attribute values 367B are determined by the state interface algorithm module 363.

The state interface algorithm module 363 may comprise a state interfacing algorithm 366 which may further comprise a state selection algorithm 366A and a state scoring algorithm 366B. The state interfacing algorithm 366 generally reviews potential combinations of state interface attribute values against input data and outputs the set of state interface attribute values that maximizes relevance such as peerness. The state selection algorithm 366A generally generates the combinations of states attribute values to be reviewed, based on a database of predetermined possible values. The state scoring algorithm 366B generally computes scores for interface attributes (e.g., peerness, relevant, appropriateness, etc.) to determine the state interface attribute value to be communicated to the output interface.

The response interface engine 364 generally determines the output response interface attributes and values 368 provided by the AI agent system. The output response interface attributes and values 368 of the response interface engine 364 may comprise response interface attributes 368A such as for example only and not for limitation audible sound, visual image, utterances, peerness, relevance, appropriateness or presence. Typically, the response interface attributes 368A are predefined in the state and response interface attribute database 384. Response interface attribute values 368B for these attributes reflect an objective representation of these attributes and are determined by the response interfacing algorithm 369. The response interfacing algorithm 369 may comprise a response selection algorithm 369A to identify potential response attribute values and the response scoring algorithm 369B scores the potential response interface attribute values to determine the response interface attribute value to be communicated to the output interface. For example, and not for limitation, examples of response interface attribute values for the response interface attribute of peerness may be the specific color or size of a graphic icon or the specific volume of an audible response to match the volume of other participants. For example, and not for limitation, examples of state attribute values for the state attribute of presence may comprise a changing graphic icon, a specific color, a specific size of icon or the specific volume of an audible response to mimic a human's breathing. Typically, the response interface attribute values 368B are determined by the response interface algorithm module 365.

### Output Interface—Dynamic Interface

As shown in FIGS. 3D-3G, the output state interface attributes and values may be used to provide a response or a representation of state through a dynamic interface. The dynamic features of the interface may change over a temporal period such as time.

FIGS. 3D-3G show example visualizations of state provided as output in the reference system, including idle (FIG. 3D), thinking (FIG. 3E), speaking (FIG. 3F), and ready to interject (FIG. 3G). The visualizations represent different graphical images to represent different states of the AI agent system. The visualizations may differ through different interface attributes, such as color, contrast, size, motion, text, shape, texture/patterns, space or form. The dynamic interface may change through different states or may change as it stays in one state. For example, the “idle” state shown in FIG. 3D may have the circular shape expand and contract while in the idle state to give the sense of the AI agent system being present but idle and the “thinking” state shown in FIG. 3E may have the outer ring of the image rotate around the image to give the sense of the AI agent system “thinking”.

These state interface attributes may also comprise nonvisual interface attributes such as sound, smell, texture, vibration or other sensory attributes.

These state interface attributes may also comprise multiple interface attributes such as a visual attribute combined with other attributes. For example, a transition from idle to thinking would be a change in the visual attribute and may also include the phrase “that's a good question, let me think about that”.

Response interface attributes may be similarly dynamic to represent a response of the AI agent system. For illustration purposes only and not for limitation, examples output response interface attributes and values may include utterances, sounds, words, textual or other data provided as a response to the input data.

In one example embodiment the attributes and the attribute values provided by the interface engine to the output interface are specifically chosen to represent “peerness” as an interface attribute. This peerness is a sociotechnical attribute specifically intended to help portray the AI agent system as a “peer” to the other entities is it interacting with. For illustration purposes only and not for limitation, examples of interface attributes for peerness for a graphic icon may comprise size, shape, color, rate of change or textual content. For illustration purposes only and not for limitation, examples of interface attributes for peerness for an audible interface may comprise volume, choice of words, content of words or rate of word/data flow. The values for these attributes would be selected in an attempt to have the interface come across as a peer of the other participants.

The dynamic features of the interface result in unique features for the AI agent system such as:
the state interface attribute values change as the AI agent system's state changes;
the state and response interface attribute values may be tailored to reflect more “peerness” of the AI agent system; and
the state interface attribute values may change to portray the AI agent system as a more interactive contributor to a dialog.

### Contextualizer Module and A Context Engine

As shown in FIG. 1, the contextualizer module 135 may be a component of the data processor or it may be a system contexualizer module/engine 150 to provide contextualization features to other components of the AI agent system. The contextualizer module generally takes data and identifies a context data to contextualize, or further define that data.

For illustration purposes and not for limitation, one example embodiment of methods used within the contextualizer module is shown in FIG. 5 and generally comprises the steps of initializing and creating knowledge graphs at 535A, receiving input data and updating the knowledge graphs at 535B, contextualizing and input data at to make a recommendation of context data or related products at 535C, and communicating the results.

Initializing context data at 535A is generally the population of multi-layer knowledge graphs with properties and property values defined by the domain model and the definition of context. Context data is created by unifying input data through tools such as NLP processes or through the use of tools such as the synonymy layer. With the unified input data, vertex and relationship property values can be determined according to the domain model and these values are used to populate the appropriate knowledge graph. The multi-layer knowledge graphs may be populated with attributes such as: a topic attribute, a participant attribute, a agenda attribute, a place attribute, a modality attribute, a read ahead attribute, and a location attribute. The multi-layer knowledge graphs may be populated with attributes such as: a physiological data of the entity, a behavioral data of the entity, a location data of the entity; and an orientation data of the entity. Populated knowledge graphs are used as prior knowledge graphs to be updated and used with current interaction information.

Receiving input data at 535B is generally the system components receiving current interaction information, such as communication data as input data for the system user or receiving data from information sources the user is subscribed to. This input data is also used to update and create current knowledge graphs.

Contextualizing and making a recommendation at 535C generally comprises the use of the recommendation algorithm with the knowledge graphs. The recommendation algorithm takes graph nodes pairs and determines a connection strength measure of the pairs and a similarity measure of the pairs. Each of the graph nodes are factored with their corresponding connection strength and similarity measures to define a ranking of relevancy of the nodes and the most relevant node is then used as the recommendation.

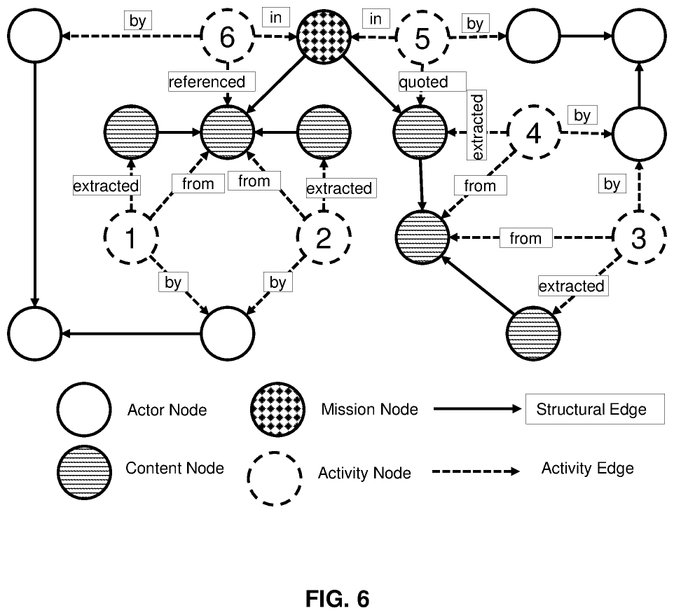

Referring to FIG. 6 and the system's definition of context, actors, content, mission and activity are modeled as nodes of multi-layered graphs. In embodiments of the disclosed activity-centric systems, activity is modeled explicitly as nodes within the graph. Each node represents an action that is performed by an actor and, optionally, operates over content to achieve a mission objective. This definition allows us to simplify and enhance a domain modeling approach to four layers:
The actor layer is comprised of a two node types, the actor node, which represents discrete human or machine entities within the system, and the group node, which represent related collections of human or machine actors.
The content layer is a heterogeneous layer representing the data over which actors operate. It is equivalent, in many regards, to the traditional form of a knowledge graph, linking discrete source data nodes together through myriad extracted nodes derived from automated analytical methods or explicitly created from actor interactions with the system.
The mission layer is a heterogeneous layer that represents the goals, objectives, tasks, requirements, constraints, products, and the relationships there-between, that define the workflow. The relationships between these entities are typically defined by the domain, policy, or best practices of the organization. One common example would be TaskN having a Create relationship to ProductQ.
The activity layer is a homogenous collection of the semantic activity nodes described above. The core of each activity node is the action, start time, and end time attributes, stored as properties on the node. Additional properties can be stored depending on the domain needs. The semantics of that action are modeled as four types of relationships: inputs, outputs, actors, and mission. Inputs and outputs model the semantic of content transformation within the work process, which can be extracting or aggregating data into relevant information. Actor and mission relationships capture the semantics for who is performing the necessary work. An activity node must always have an actor and a mission relationship. Input and output relationships are not required unless the action mutates content.

In this layered model, the activity layer acts as a connective tissue to fuse the knowledge graphs, allowing for use case-specific implementation of the actor, content, and mission layers in the system. FIG. 6 illustrates the approach for an information analysis use case. Activity is represented by discrete activity nodes in the graph, with edges pointing the associated actor (actor node), mission (mission node), and/or content (note) entities. Activities 1, 2, 3, and 4 represent content extraction by an actor. They use “by” relationships to denote the actor, “from” relationships to identify the source content, and “extracted” relationships to identify the newly created content. Activities 5 and 6 represent the actions of “referencing” and “quoting” content in a product. They use “by” relationships to denote the actor, “in” relationships to denote the product, and relationships with semantically meaningful labels (“referenced” and “quoted”) to denote the specific type of action that was taken. The results of these activities are represented as new relationships (solid arrow) in the graph that link the associated actors, content, and/or mission elements to each other directly using a separate set of semantic layers, such as provenance or structure. One advantage of this multi-layered graph approach is that it enables multiple types of pattern recognition in the graph using different graph traversals. These differences can be leveraged independently or jointly by analytics, enabling several assessments of the data space.

Data for the activity nodes is captured by monitoring and logging the interaction information such as the conversation or the activity of the analyst. Monitoring and logging interaction information such as dialog is monitored as described herein. Activity logging as may be used with an analyst is a well-documented practice in both academic and commercial realms. Traditional approaches model system-level events, such as mouse clicks, keystrokes, and/or window focus changes, then use post-hoc analyses to derive insights. These traditional methods have shortcomings as they require significant additional information to imbue the system events with process semantics and are not well-suited to dynamic task changes. Instead, the disclosed systems capture and represent activity semantics explicitly, by translating system-level events into semantic events imbued with the requisite data from an activity modeling approach within the user interface. Data representing activity semantics may comprise any set of data sufficient to populate the node and represent the activity. In one embodiment, a minimum tuple that must be captured is defined as (actor; target; action), where target can be an entity in the mission or content layers. This tuple is appropriate when the actor is mutating a property of an element, such as rating the credibility of the information contained in a snippet of text. In some embodiments, more complex activity may also include an output. In this case, the tuple would be adjusted to be (actor; source; output; action). Limits on the tuples that are captured are not required and it is recommend that the system capture as much detail as possible. It is significant to label the actions of the activity nodes in a semantically meaningful way. Looking again at FIG. 6, the activity nodes that capture the creation of derivative knowledge elements use from and extracted relationships to denote the source and the output. The precise semantics of these relationships and analytics thereover will change with the operational domain, use case, etc.

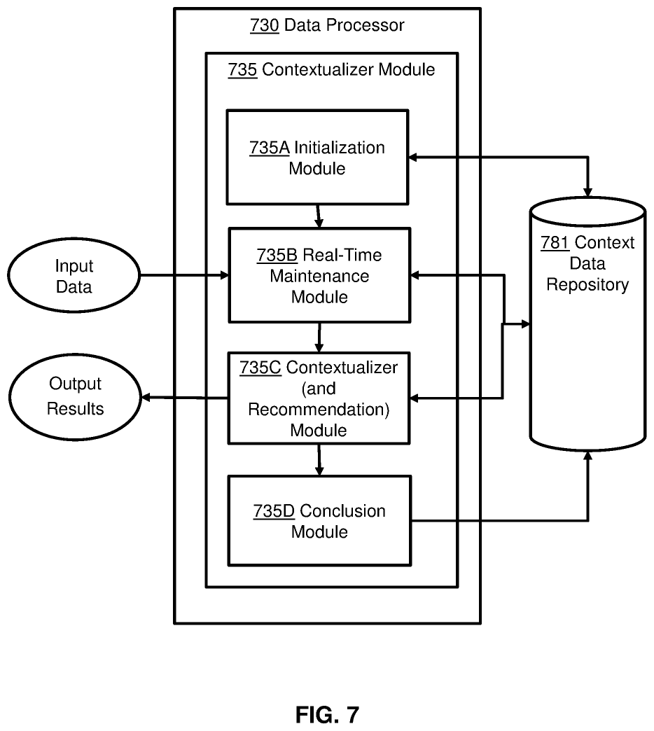

FIG. 7 illustrates a system overview of an example embodiment of the contextualizer module 735 of data processor 730 used to establish, determine, maintain, and store context information over time. The AI agent system relies on the contextualizer module to generate appropriate responses, as described above. The illustrated contextualizer module comprises multiple modules: the initialization module 735A, the real-time maintenance module 735B, the contextualizer module 735C, and the conclusion module 735D. The initialization module 735A generally constructs a current knowledge graph and links to previous related knowledge graphs. The real-time maintenance module 735B generally updates the current knowledge graph based on the interactions of the AI agent systems interactions. The contextualizer module 735C generally finds contextual information and recommends the most contextually relevant information for use by the system. The conclusion module 735D generally saves the current knowledge graph for future use. The modules may obtain and/or save relevant data in the context data repository 781.

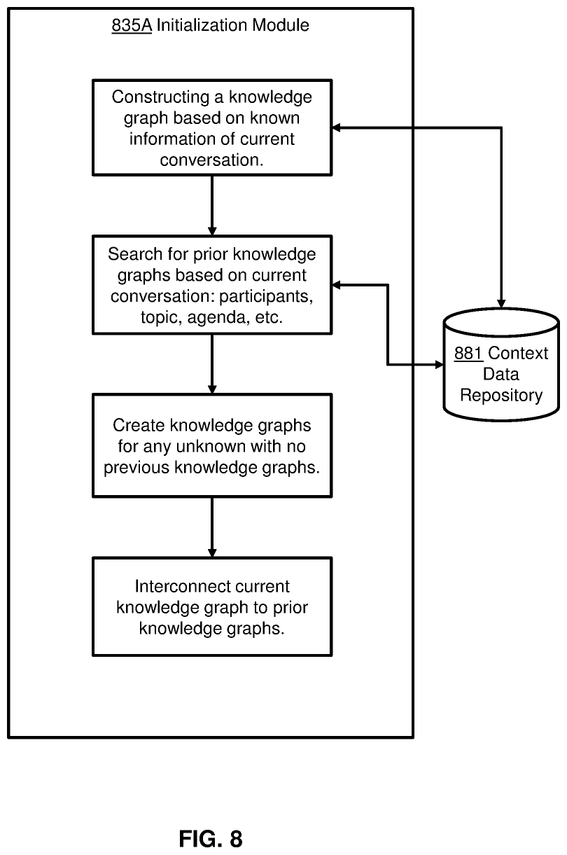

FIG. 8 Illustrates a general process of an example embodiment of an initialization module 835A. As shown, the initialization module may use any known information of a conversation to load previously generated knowledge graphs used by the contextualizer module. This previous information may be obtained from the context data repository 881 in the system database. The types of information used in the initialization comprises known information regarding the conversation and conversation participants' information. The conversation information comprises the data known at the onset of the conversation such as: date, time, and location of the conversation, the topic of the conversation, an agenda, documents pertinent to the conversation, and the list of initial participants in the conversation.

With the known list of initial participants in the conversation, the initialization module can also load the information of the participants. This information on the participants may comprise title, position in an organization, role in the conversation (moderator, participant, subject matter expert, etc.), and location as may be obtained from the context data repository 881. Additionally, any prior conversations knowledge graphs previously generated by the contextualizer module can be obtained. These previously generated knowledge graphs can be found based on the topic of the current conversation, the participants in the current conversation, or based on other information captured in the initialization module. The initialization module is complete once the current knowledge graph is interconnected to the previous knowledge graphs based on their common attributes including topic, participant, location, agenda items, etc.

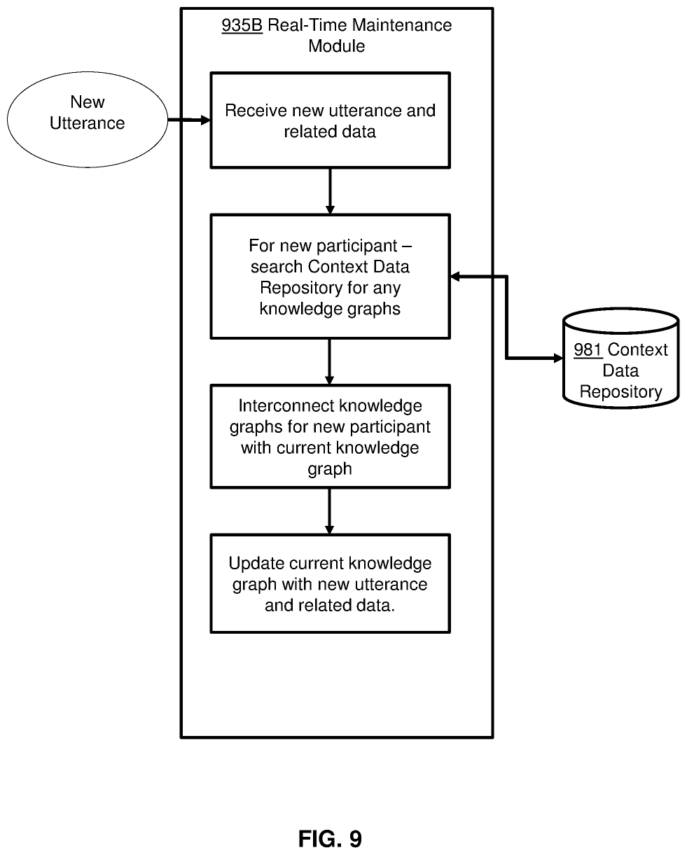

FIG. 9 illustrates a general process overview of the real-time maintenance module 935B whereby context is updated in real-time as utterances are received. When a new utterance is received, the maintenance module examines the current conversation's knowledge graph to see if the participant creating the utterance is represented in the knowledge graph. If the participant is new to the conversation, the context data repository 981 is searched for any knowledge graphs associated with the new participant. The found knowledge graphs for the new participant are interconnected to the current conversation's knowledge graph.

The maintenance module updates the current conversation with the utterance which includes information such as the participant provided the utterance, and the time of the utterance was made. Other information about the utterance may be captured such as volume of a spoken utterance and the pitch of the utterance may be captured and included in the knowledge graph. Beyond the utterance and its related information, data may be captured from the participant in real-time which could include the physiological data (heart rate, respiration, galvanic skin response, etc.), behavioral data, (positional, tasking, activity data, etc.), and environmental data (temperature, humidity, location data, etc.). This data is then integrated in the knowledge graph.

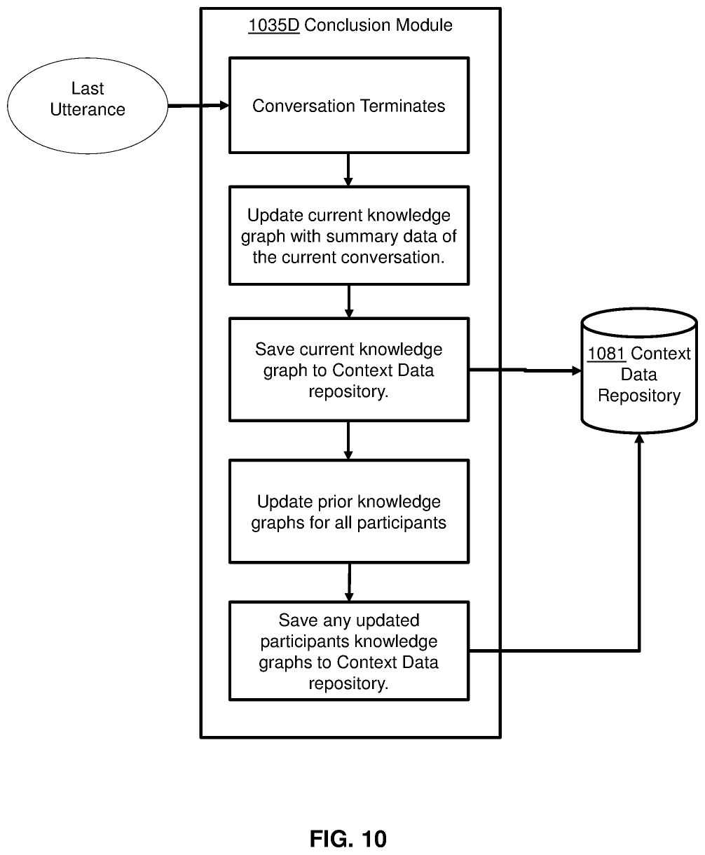

FIG. 10 illustrates a general process overview of the conclusion module 1035D which is started as the last utterance of the conversation is indicated. Upon an indication and processing of the last utterance, any post-conversation processing is performed which can include summary about the conversation such as time, number of utterances, number of participants, etc. The current conversations updated knowledge graph is then saved to the context data repository 1081 of the system database. Any updates to each of the participants' knowledge graphs are performed based on the data received during the just terminated current conversation. These participant knowledge graphs are then stored to the context data repository 1081 of the system database.

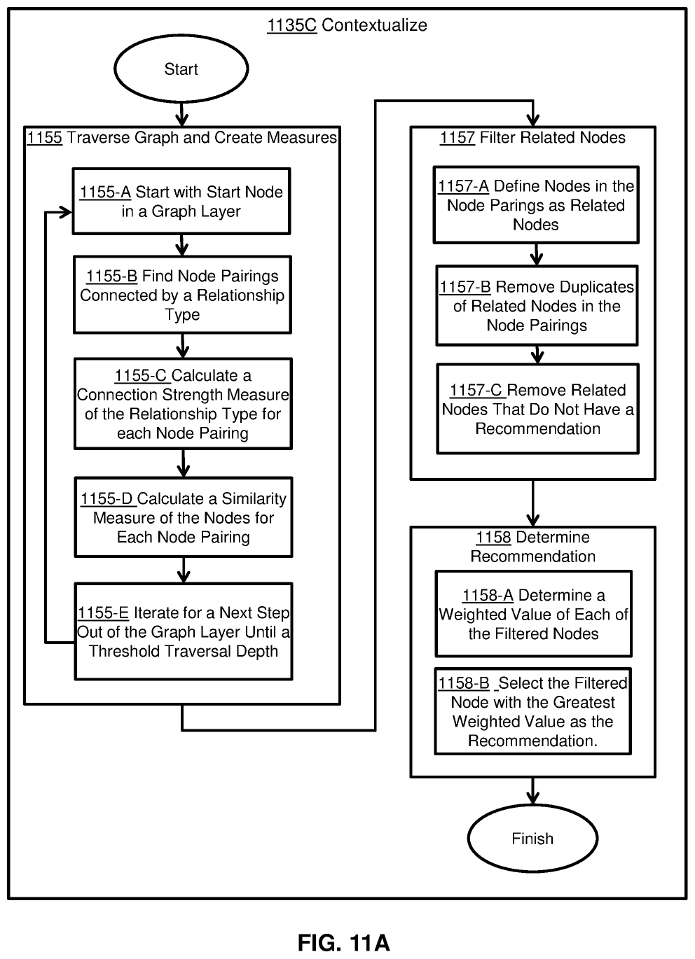

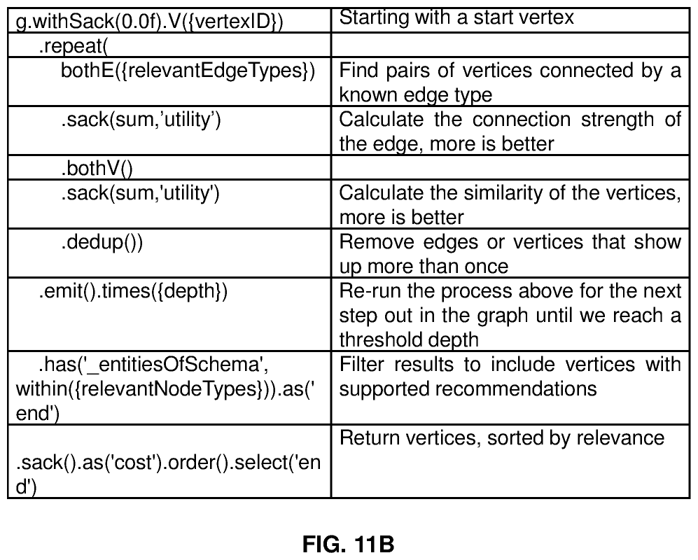

FIGS. 11A and 11B illustrate an example embodiment of a suitable contextualization process and recommendation algorithm for a contexualization module 1135C or system context engine. As shown in FIG. 11A, the process generally comprises traversing the knowledge graph to create measures at 1155, filter related nodes at 1157 and determine a recommendation from the related nodes at 1158. FIG. 11A illustrated an embodiment that is suitable for a graph traversal where the start vertex may be an activity node, the relationship type may be a reference and the connect vertex may be a content node.

In FIG. 11A, traversing the multi-layer knowledge graphs at 1155 generally comprise, starting with a start node in the graph layer at 1155-A:
at 1155-B, identify a pairing of the start node with other nodes connected by any relationship type in a graph layer of the multi-layered knowledge graph; code.
at 1155-C, calculate a connection strength measure of the relationship type for the node pairings and associate the connection strength measure to each of the nodes;
at 1155-D, calculate a similarity measure of the nodes in the node pairing and associate the similarity measure to each of the nodes; and
at 1155-E, iterate steps 1155-A-1155-D for a next step out of the graph layer for subsequent pairings of the nodes connected by any relationships type until a threshold traversal depth of steps.

Filtering related nodes at 1157 generally comprise the steps of:
at 1157-A, define each of the nodes in the node pairings and the subsequent node pairings as a plurality of related nodes;
at 1157-B, filter the plurality of related nodes by removing duplicates of related nodes to define a plurality of filtered nodes as a plurality of potential recommendations; and
at 1157-C, filter the plurality of related nodes by removing related nodes that do not have a recommendation or automation.

Determining a recommendation at 1158 generally comprises the steps of:
at 1158-A, determine a weighted value of each of the plurality of filtered nodes as a function of the connection strength measure and the similarity measure; and
at 1158-B, select the filtered node with the greatest weighted value as the context-aware data or recommendation.

FIG. 11B illustrated an example recommendation algorithm in pseudo-code.

### One Embodiment of Methods of Use of the Contextualizer Module

In one example embodiment, a contextualizer module for conversation supports the AI agent system by continuously providing updated context as new utterances are made in a conversation. In this embodiment, a discussion will include a topic, a location, three human participants, and the AI agent system. The topic will be discussion, the AI agent system comprising one or more processors, and one or more memory elements including instructions that, when executed, cause the one or more processors to perform operations comprising: collecting information about a current discussion. generating one or more potential statement for the AI agent system, constructing one or more utterance from the one or more potential statements, and communicating the one or more utterance through a user interface.

### One Embodiment of Methods of Use of the AI Agent System

FIG. 2 illustrates a general process overview of operating an AI agent system. As shown, the methods generally comprise receiving input data at 212, determining agent attributes and attribute values at 240, determining interface attributes and attribute values at 260 and communicating the output data at 270 to the output interface.

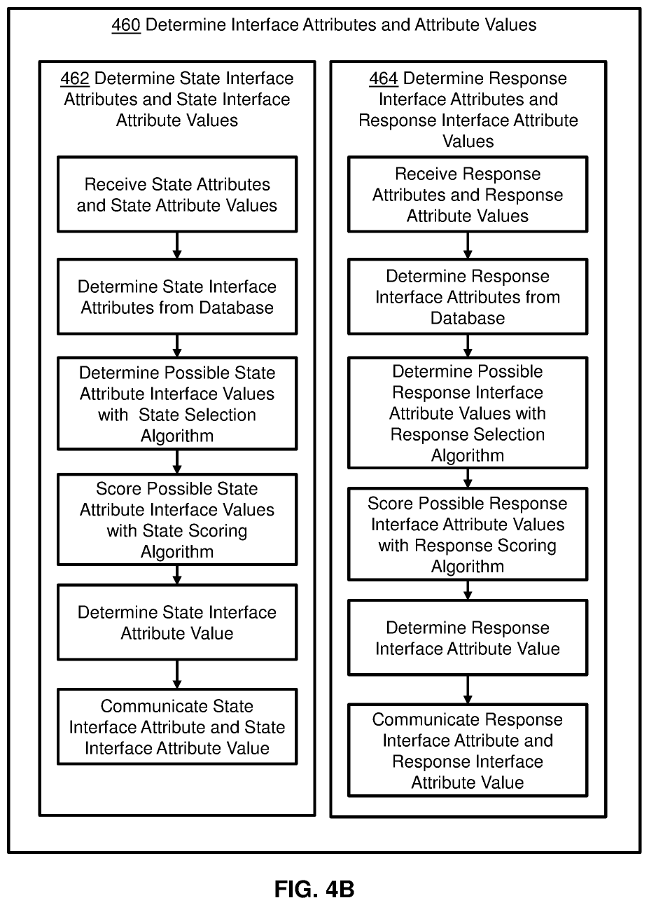

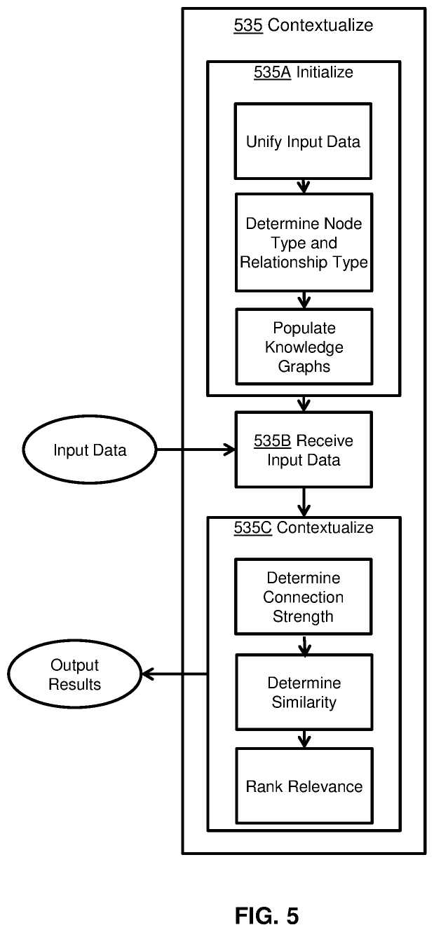

FIG. 4A illustrates a general process overview of operating portions of an AI agent system after receipt of formatted input data. Discourse typically begins with the participants. Their inputs are collected, contextualized, tagged with meta-data and formatted before being sent to determine agent attributes and attribute values at 440. At 442, the state of the agent is determined as state attributes and state attribute values. Within this process, formatted input data and meta-data is received as input data. From this input data, state attributes are determined by a mapping with pre-defined state attribute data in the database. The state selection algorithm determines possible state attribute values and the state scoring algorithm ranks the possible state attribute values. The attribute value that maximizes the reward in the reinforcement learning algorithm is selected as the state attribute value to be communicated to the interface engine. At 444 of FIG. 4A, the response attributes and response attribute values are determined. Within this process, formatted input data and meta-data is received as input data. From this input data, response attributes are determined by a mapping with pre-defined response attribute data in the database. The response selection algorithm determines possible response attribute values and the response scoring algorithm ranks the possible response attribute values. The attribute value that maximizes the reward in the reinforcement learning algorithm is selected at the response attribute value to be communicated to the interface engine.

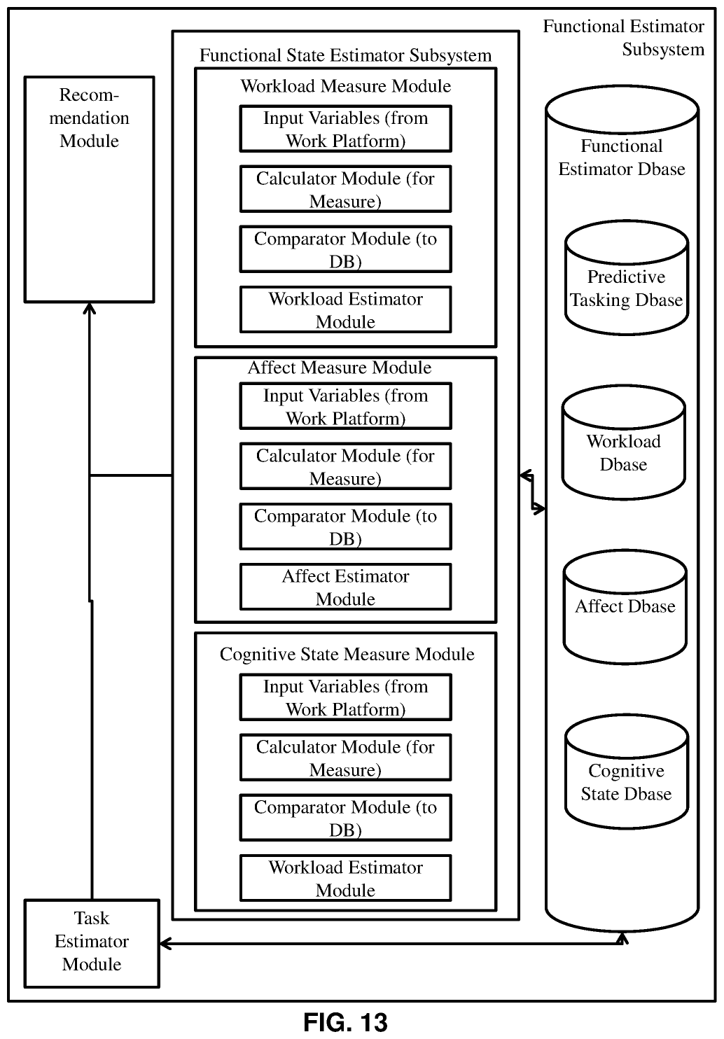

In some embodiments, the step of determining the state of the agent may comprise steps performed by a functional state estimation system as disclosed in co-pending U.S. patent application Ser. No. 17/000,327, entitled “SYSTEMS AND METHODS TO ESTIMATE A USER FUNCTIONAL STATE” (MOTOR) and filed on Aug. 23, 2020, the entire contents of which are incorporated herein. For example, see the functional estimator subsystem features shown in FIG. 13. In these embodiments, the functional state estimation system may comprise a source of user inputs that are used to operate an underlying work platform (or may be inputs as part of a dialog/conversation in the artificial intelligence agent system artificial intelligence agent system), a functional estimator subsystem to estimate the user functional state and output devices to communicate the results of the functional estimator subsystem. The functional estimator subsystem generally receives data from the work platform, makes determinations of the user's functional state, including their workload, and communicates these determination results to be displayed on a user interface. Some embodiments of the functional estimator subsystem may include the user interface sending data back to the work platform for subsequent cycles. In some embodiments, the functional state estimator unobtrusively estimates the user state to help manage the workload of the user or to be used as input to another system such as an artificial intelligence agent system. In these embodiments, generally, for measuring a user's functional state, factors such as workload, affect and cognitive state may be considered by the functional state estimator subsystem modules. These functional state factors may be measured using modeling or calculation approaches such as activity rates, sequences or binary measures that result in an objective measure value. These functional state factors may also be measured using a number of modeling approaches such as but not limited to, rule-based models, statistical models, machine learning models, pattern matching and neural network models, etc. These modeling approaches may use any input data or input variables from the work platform such as those described herein. For example, consider a configuration where an engineer user has three possible states: receptive, analytic, and fatigued. The HCI data such as keypresses and mouse-clicks are stored in a data-structure in a database, fetched from the database along with the time-intervals between the HCI, and then subsequently used by the models to make calculations, measures, estimates and recommendations. The functional estimator subsystem may estimate a wide variety of attributes and states from this input data.

Although not shown in FIG. 4A, determining the response attributes and response attribute values at 444 may also include generating possible responses with a response generation algorithm and generative response model. Those possible responses are ranked with a scoring algorithm and the possible response that maximizes the reward in the reinforcement learning algorithm is selected at the response attribute and response attribute value to be communicated to the interface engine.

FIG. 4B, illustrates a general process overview of operating an AI agent system after receipt of the state attributes, state attribute values, response attributes and response attribute values from the agent attribute engine at 460. At 462, the state interface attributes and state interface attribute values are determined. Within this process, the state attributes and state attribute values are received. From this data, state interface attributes are determined by a mapping with pre-defined state interface attribute data in the database. The state selection algorithm determines possible state attribute values and the state scoring algorithm ranks the possible state interface attribute values. The interface attribute value that maximizes the reward in the reinforcement learning algorithm is selected at the state interface attribute value to be communicated to the output interface. At 464 of FIG. 4B, the response interface attributes and response interface attribute values are determined. Within this process, the response attributes and response attribute values are received. From this data, response interface attributes are determined by a mapping with pre-defined response interface attribute data in the database. The response selection algorithm determines possible response interface attribute values and the response scoring algorithm ranks the possible response interface attribute values. The interface attribute value that maximizes the reward in the reinforcement learning algorithm is selected at the response interface attribute value to be communicated to the output interface.

### One Embodiment of an AI Agent System implemented in a Software Program Product Executed by a Processor Based System

As will be readily apparent to those skilled in the art, one embodiment of the AI conversational agent systems and methods can be embodied in hardware, software, or a combination of hardware and software. For example, a computer system or server system, or other computer implemented apparatus combining hardware and software adapted for carrying out the methods described herein, may be suitable. One embodiment of a combination of hardware and software could be a computer system with a computer program that, when loaded and executed, carries out the respective methods described herein. In some embodiments, a specific use computer, containing specialized hardware or computer programming for carrying out one or more of the instructions of the computer program, may be utilized.

Computer program, software program, program, software or program code in the present context mean any expression, in any language, code or notation, of a set of instructions readable by a processor or computer system, intended to cause a system having an information processing capability to perform a particular function or bring about a certain result either directly or after either or both of the following: (a) conversion to another language, code or notation; and (b) reproduction in a different material form. A computer program can be written in any form of programming language, including compiled or interpreted languages, and it can be deployed in any form, including as a stand-alone program or as a module, component, subroutine, or other unit suitable for use in a computing environment.

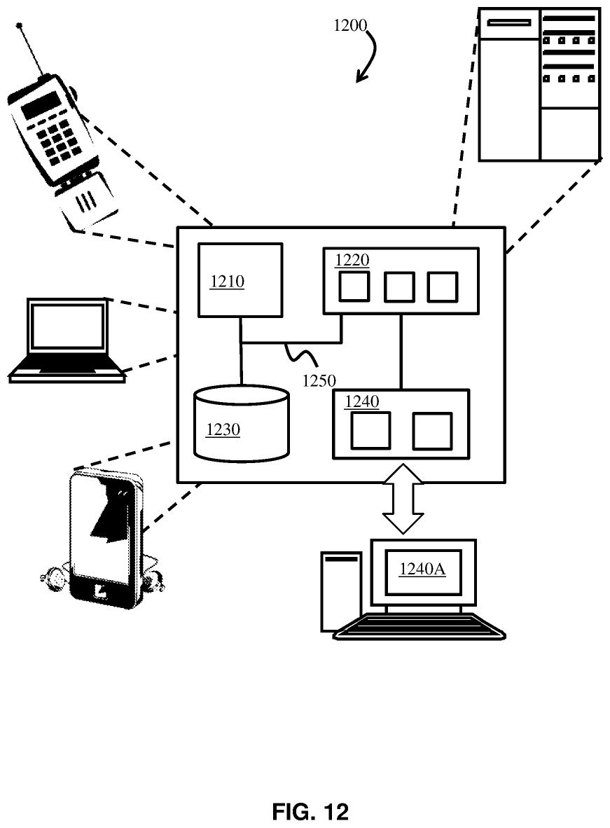

FIG. 12 is a schematic diagram of one embodiment of a computer system 1200 by which the AI conversational agent methods may be carried out. The computer system 1200 can be used for the operations described in association with any of the computer implemented methods described herein. The computer system 1200 includes at least one processor 1210, a memory 1220 and an input/output device 1240. Each of the components 1210, 1220, and 1240 are operably coupled or interconnected using a system bus 1250. The computer system 1200 may further comprise a storage device 1230 operably coupled or interconnected with the system bus 1250.

The processor 1210 is capable of receiving the instructions and/or data and processing the instructions of a computer program for execution within the computer system 1200. In some embodiments, the processor 1210 is a single-threaded processor. In some embodiments, the processor 1210 is a multi-threaded processor. The processor 1210 is capable of processing instructions of a computer stored in the memory 1220 or on the storage device 1230 to communicate information to the input/output device 1240. Suitable processors for the execution of the computer program instruction include, by way of example, both general and special purpose microprocessors, and a sole processor or one of multiple processors of any kind of computer.

The memory 1220 stores information within the computer system 1200. Memory 1220 may comprise a magnetic disk such as an internal hard disk or removable disk; a magneto-optical disk; an optical disk; or a semiconductor memory device such as PROM, EPROM, EEPROM or a flash memory device. In some embodiments, the memory 1220 comprises a transitory or non-transitory computer readable medium. In some embodiments, the memory 1220 is a volatile memory unit. In another embodiments, the memory 1220 is a non-volatile memory unit.

The processor 1210 and the memory 1220 can be supplemented by, or incorporated in, ASICs (application-specific integrated circuits).

The storage device 1230 may be capable of providing mass storage for the system 1200. In various embodiments, the storage device 1230 may be, for example only and not for limitation, a computer readable medium such as a floppy disk, a hard disk, an optical disk, a tape device, CD-ROM and DVD-ROM disks, alone or with a device to read the computer readable medium, or any other means known to the skilled artisan for providing the computer program to the computer system for execution thereby. In some embodiments, the storage device 1230 comprises a transitory or non-transitory computer readable medium.

In some embodiments, the memory 1220 and/or the storage device 1230 may be located on a remote system such as a server system, coupled to the processor 1210 via a network interface, such as an Ethernet interface.

The input/output device 1240 provides input/output operations for the system 1200 and may be in communication with a user interface 1240A as shown. In one embodiment, the input/output device 1240 includes a keyboard and/or pointing device. In some embodiments, the input/output device 1240 includes a display unit for displaying graphical user interfaces or the input/output device 1240 may comprise a touchscreen. In some embodiments, the user interface 1240A comprises devices such as, but not limited to a keyboard, pointing device, display device or a touchscreen that provides a user with the ability to communicate with the input/output device 1240.

The computer system 1200 can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wireless phone networks and the computers and networks forming the Internet.

### REFERENCES

The publication and other material used herein to illuminate the invention or provide additional details respecting the practice of the invention, are incorporated by reference herein, and for convenience are provided in the following bibliography.

Citation of the any of the documents recited herein is not intended as an admission that any of the foregoing is pertinent prior art. All statements as to the date or representation as to the contents of these documents is based on the information available to the applicant and does not constitute any admission as to the correctness of the dates or contents of these documents.
[1] A. Radford, J. Wu, R. Child, D. Luan, D. Amodei, and I. Sutskever, “Language models are unsupervised multitask learners,” 2019.
[2] Z. Yang, Z. Dai, Y. Yang, J. Carbonell, R. Salakhutdinov, and Q. Le, “Xlnet: Generalized autoregressive pretraining for language understanding,” 06 2019.
[3] J. Vincent, “Openai's new multitalented ai writes, translates, and slanders,” The Verge. The Verge, February, vol. 14, 2019.
[4] A. Destine-DeFreece, S. Handelsman, T. Light Rake, A. Merkel, and G. Moses, “Can gpt-2 replace a sex and the city writers' room?,” 2019.
[5] G. Branwen, “Gpt-2 neural network poetry,” 2019.
[6] L. Qin, A. Bosselut, A. Holtzman, C. Bhagavatula, E. Clark, and Y. Choi, “Counterfactual story reasoning and generation,” arXiv preprint arXiv: 1909.04076, 2019.
[7] V. Kepuska and G. Bohouta, “Next-generation of virtual personal assistants (microsoft cortana, apple siri, amazon alexa and google home),” in 2018 IEEE 8^{th} Annual Computing and Communication Workshop and Conference (CCWC), pp. 99-103, IEEE, 2018.
[8] X. Peng, S. Li, S. Frazier, and M. Riedl, “Fine-tuning a transformer-based language model to avoid generating non-normative text,” arXiv preprint arXiv: 2001.08764, 2020.
[9] A. Vaswani, N. Shazeer, N. Parmar, J. Uszkoreit, L. Jones, A. Gomez, L. Kaiser, and I. Polosukhin, “Attention is all you need,” 06 2017.
[10] S. Sukhbaatar, A. Szlam, J. Weston, and R. Fergus, “End-to-end memory networks,” Arxiv, pp. 1-11, 03 2015.
[11] C. Zhou, C. Sun, Z. Liu, and F. Lau, “A c-lstm neural network for text classification,” 11 2015.
[12] X. Qiu, T. Sun, Y. Xu, Y. Shao, N. Dai, and X. Huang, “Pre-trained models for natural language processing: A survey,” arXiv preprint arXiv: 2003.08271, 2020.
[13] A. Wang, A. Singh, J. Michael, F. Hill, O. Levy, and S. Bowman, “Glue: A multi-task benchmark and analysis platform for natural language understanding,” 04 2018.
[14] M. L. Mauldin, “Chatterbots, tinymuds, and the turing test: Entering the loebner prize competition,” in AAAI, vol. 94, pp. 16-21, 1994.
[15] A. Ram, R. Prasad, C. Khatri, A. Venkatesh, R. Gabriel, Q. Liu, J. Nunn, B. Hedayatnia, M. Cheng, A. Nagar, et al., “Conversational ai: The science behind the alexa prize,” arXiv preprint arXiv: 1801.03604, 2018.
[16] R. Meyer von Wolff, S. Hobert, and M. Schumann, “How may i help you?—state of the art and open research questions for chatbots at the digital workplace,” in Proceedings of the 52nd Hawaii International Conference on System Sciences, 2019.
[17] C. D. Manning, P. Raghavan, and H. Sch\ddot{ }utze, Introduction to information retrieval. Cambridge university press, 2008.
[18] S. Feng and P. Buxmann, “My virtual colleague: A state-of-the-art analysis of conversational agents for the workplace,” in Proceedings of the 53rd Hawaii International Conference on System Sciences, 2020.
[19] R. Mullins, A. Fouse, G. Ganberg, and N. Schurr, “Practice makes perfect: Lesson learned from five years of trial and error building context-aware systems,” in Proceedings of the 53rd Hawaii International Conference on System Sciences, 2020.
[20] S. Reshmi and K. Balakrishnan, “Implementation of an inquisitive chatbot for database supported knowledge bases,” sadhana, vol. 41, no. 10, pp. 1173-1178, 2016.
[21] F. Hendriks, C. X. Ou, A. K. Amiri, and S. Bockting, “The power of computer-mediated communication theories in explaining the effect of chatbot introduction on user experience,” interaction, vol. 12, p. 15, 2020.
[22] U. Gnewuch, S. Morana, M. Adam, and A. Maedche, “Faster is not always better: understanding the effect of dynamic response delays in human-chatbot interaction,” 2018.
[23] R. M. Schuetzler, M. Grimes, J. S. Giboney, and J. Buckman, “Facilitating natural conversational agent interactions: lessons from a deception experiment,” 2014.
[24] J. Visser, J. Lawrence, J. H. Wagemans, C. Reed, et al., “Revisiting computational models of argument schemes: Classification, annotation, comparison.,” in COMMA, pp. 313-324, 2018.
[25] M. Sato, K. Yanai, T. Miyoshi, T. Yanase, M. Iwayama, Q. Sun, and Y. Niwa, “End-to-end argument generation system in debating,” in Proceedings of ACL-IJCNLP 2015 System Demonstrations, pp. 109-114, 2015.
[26] S. Gretz, R. Friedman, E. Cohen-Karlik, A. Toledo, D. Lahav, R. Aharonov, and N. Slonim, “A large-scale dataset for argument quality ranking: Construction and analysis,” in Proceedings of the 34th AAAI conference on artificial intelligence, 2020.
[27] L. Ein-Dor, E. Shnarch, L. Dankin, A. Halfon, B. Sznajder, A. Gera, C. Alzate, M. Gleize, L. Choshen, Y. Hou, et al., “Corpus wide argument mining—a working solution,” in Proceedings of the 34th AAAI conference on artificial intelligence, 2020.
[28] M. Hildebrandt, J. A. Q. Serna, Y. Ma, M. Ringsquandl, M. Joblin, and V. Tresp, “Reasoning on knowledge graphs with debate dynamics,” in Proceedings of the 34^{th} AAAI conference on artificial intelligence, 2020.
[29] D. Graham and T. T. Bachmann, Ideation: The birth and death of ideas. John Wiley & Sons, 2004.
[30] S. F. Slater, J. J. Mohr, and S. Sengupta, “Radical product innovation capability: Literature review, synthesis, and illustrative research propositions,” Journal of Product Innovation Management, vol. 31, no. 3, pp. 552-566,2014.
[31] P. Pirolli and S. Card, “The sensemaking process and leverage points for analyst technology as identified through cognitive task analysis,” in Proceedings of international conference on intelligence analysis, vol. 5, pp. 2-4, McLean, VA, USA, 2005.
[32] D. J. Zelik, E. S. Patterson, and D. D. Woods, “Judging sufficiency: How professional intelligence analysts assess analytical rigor,” in Proceedings of the Human Factors and Ergonomics Society Annual Meeting, vol. 51, pp. 318-322, SAGE Publications Sage CA: Los Angeles, CA, 2007.
[33] T. Strohmann, S. Fischer, D. Siemon, F. Brachten, C. Lattemann, S. Robra-Bissantz, and S. Stieglitz, “Virtual moderation assistance: Creating design guidelines for virtual assistants supporting creative workshops.,” in PACIS, p. 80, 2018.
[34] E. Bittner and O. Shoury, “Designing automated facilitation for design thinking: a chatbot for supporting teams in the empathy map method,” in Proceedings of the 52nd Hawaii International Conference on System Sciences, 2019.
[35] Q. Li, M. A. Vasarhelyi, et al., “Developing a cognitive assistant for the audit plan brainstorming session,” 2018.
[36] J. B. Grossman, D. D. Woods, and E. S. Patterson, “Supporting the cognitive work of information analysis and synthesis: A study of the military intelligence domain,” in Proceedings of the Human Factors and Ergonomics Society Annual Meeting, vol. 51, pp. 348-352, SAGE Publications Sage CA: Los Angeles, CA, 2007.
[37] R. L. Baskerville and A. T. Wood-Harper, “A critical perspective on action research as a method for information systems research,” Journal of information Technology, vol. 11, no. 3, pp. 235-246, 1996.
[38] J. Nielsen, “Guerrilla hci: Using discount usability engineering to penetrate the intimidation barrier,” Cost-justifying usability, pp. 245-272, 1994.
[39] M. Fowler, J. Highsmith, et al., “The agile manifesto,” Software Development, vol. 9, no. 8, pp. 28-35, 2001.
[40] S. Black, D. G. Gardner, J. L. Pierce, and R. Steers, “Design thinking,” Organizational Behavior, 2019.
[41] L. Luqi and R. Steigerwald, “Rapid software prototyping,” in Proceedings of the Twenty-Fifth Hawaii International Conference on System Sciences, vol. 2, pp. 470-479, IEEE, 1992.
[42] T. Kiss and J. Strunk, “Unsupervised multilingual sentence boundary detection,” Computational Linguistics, vol. 32, pp. 485-525, 12 2006.
[43] K. R. Scherer, “The functions of nonverbal signs in conversation,” in The social and psychological contexts of language, pp. 237-256, Psychology Press, 2013.
[44] J. Bertin, “Semiology of graphics; diagrams networks maps,” tech. rep., 1983.
[45] A. M. MacEachren, How maps work: representation, visualization, and design. Guilford Press, 2004.
[46] N. Schurr, A. Fouse, J. Freeman, and D. Serfaty, “Crossing the uncanny valley of human-system teaming,” in International Conference on Intelligent Human Systems Integration, pp. 712-718, Springer, 2019.
[47] M. Harrower, “The cognitive limits of animated maps,” Cartographica: The International Journal for Geographic Information and Geovisualization, vol. 42, no. 4, pp. 349-357, 2007.
[48] Y. Zhang, M. Galley, J. Gao, Z. Gan, X. Li, C. Brockett, and B. Dolan, “Generating informative and diverse conversational responses via adversarial information maximization,” 09 2018.
[49] Y. Zhang, S. Sun, M. Galley, Y.-C. Chen, C. Brockett, X. Gao, J. Gao, J. Liu, and B. Dolan, “Dialogpt: Large-scale generative pre-training for conversational response generation,” 2019.
[50] W. Chan, N. Jaitly, Q. V. Le, and 0. Vinyals, “Listen, attend and spell: A neural network for large vocabulary conversational speech recognition,” in ICASSP, 2016.
[51] D. Pruthi, B. Dhingra, and Z. Lipton, “Combating adversarial misspellings with robust word recognition,” pp. 5582-5591, 01 2019.

We claim:

1. A processor-based method to represent an interaction information as a knowledge graph, the method comprising:
receiving a current interaction information representing a plurality of current interactions of a current conversation;
initializing a knowledge graph representing the current conversation;
maintaining the knowledge graph of the current conversation with the current interaction information; and
storing the knowledge graph of the current conversation.

2. The processor-based method of claim 1 wherein the knowledge graph representing the current conversation comprises the knowledge graph representing the current conversation connected to a prior knowledge graph.

3. The processor-based method of claim 1 wherein the step of initializing a knowledge graph of the current conversation comprises:
searching a context data repository of prior knowledge graphs to identify a prior knowledge graph with the current interaction information of the current conversation; and
connecting the knowledge graph representing the current conversation with the prior knowledge graph.

4. The processor-based method of claim 3 wherein:
the prior knowledge graphs comprise a context data; and
the method further comprises determining a context-aware data from the knowledge graph.

5. The processor-based method of claim 3 wherein the prior knowledge graph comprises an attribute selected from the group of attributes consisting of:
a topic attribute;
a participant attribute;
a agenda attribute;
a place attribute;
a modality attribute;
a read ahead attribute; and
a location attribute.

6. The processor-based method of claim 3 wherein the prior knowledge graph comprises one of the knowledge graphs found in the context data repository of prior knowledge graphs with a node representing a prior information of the current conversation.

7. The processor-based method of claim 1 wherein the step of maintaining the knowledge graph of the current conversation, the method comprising:
receiving a new utterance as a new current interaction information of the current conversation;
searching a context data repository for a prior knowledge graph for an entity contributing the new utterance to the current conversation;
interconnecting the knowledge graph of the current conversation with one of the prior knowledge graphs of the entity; and
updating the knowledge graph with the one of the prior knowledge graphs.

8. The processor-based method of claim 7 wherein the new current interaction information comprises one selected from the group consisting of:
a physiological data of the entity;
a behavioral data of the entity;
a location data of the entity; and
an orientation data of the entity.

9. The processor-based method of claim 1 wherein the initializing a knowledge graph of the current conversation, the method comprising:
receiving a last utterance of the current conversation;
updating the knowledge graph of the current conversation;
saving the knowledge graph of the current conversation to the context data repository;
updating the knowledge graph for previous knowledge graphs; and
saving previous knowledge graphs connected the current conversation to the context data repository.

10. A processor-based method to represent an interaction information as a knowledge graph, the method comprising:
receiving, from an input sensor, a current interaction information representing a plurality of current interactions of a current conversation;
initializing a knowledge graph representing the current conversation;
populating the knowledge graph of the current conversation with the current interaction information; and
storing the knowledge graph of the current conversation at an end of the current conversation.

11. A processor-based method of determining an attribute value from a dialog input to an artificial intelligence agent system, the method comprising:
receiving a dialog input data using an input sensor;
associating a dialog input data value for the dialog input data with one or more attribute value of an attribute of the artificial intelligence agent system;
determining a dialog fit between the dialog input data value and the one or more attribute value of the dialog input data; and
selecting the one of the one or more attribute value that optimizes the dialog fit as the attribute value.

12. A processor-based method of automatically determining a context-aware recommendation to a user, the method comprising:
receiving an input data;
defining, from the input data, an activity property value of an activity node corresponding to a multi-layer knowledge graph;
defining a content property value of a content node of the multi-layer knowledge graph;
defining a relationship property value of a relationship type between the content node and the activity node; and
executing a recommendation algorithm to automatically determine a context-aware recommendation for a second activity node or a second content node based on a connection strength measure and a similarity measure.

13. The processor-based method of claim 12 wherein:
the recommendation algorithm comprises a graph traversal algorithm configured to execute the method of:
(a) identifying one or more additional node pairing of a first node connected by any relationship type to another node in a graph layer of the multi-layered knowledge graph;
(b) calculating a connection strength measure of the relationship type for each node pairing and associate the connection strength measure to each of the nodes in the node pairing;
(c) calculating a similarity measure of the nodes in each node pairing and associate the similarity measure to each of the nodes in the node pairing;
(d) iterating steps (a)-(c) for a next step out of the graph layer for subsequent node pairs of nodes connected by any relationships type until a threshold traversal depth of steps;
(e) defining each of the nodes in each node pairing and the subsequent node pairings as a plurality of related nodes;
(f) filtering the plurality of related nodes to define a plurality of filtered nodes as a plurality of potential recommendations;
(g) determining a weighted value of each of the plurality of filtered nodes as a function of the connection strength measure and the similarity measure; and
(h) selecting a filtered activity node from the plurality of filtered nodes with the greatest weighted value as the context-aware recommendation.

14. The processor-based method of claim 13 wherein the context-aware recommendation to the user is a recommendation for an information product.

15. An artificial intelligence (AI) agent system configured to determining a context-aware data as an output, the AI agent system comprising:
an input interface configured to receive interaction information as an input data;
an agent subsystem comprising:
a data processor configured to determine a context-aware data from the input data,
an agent attribute engine configured to determine an attribute of the AI agent system, and
an interface engine configured to determine a response of the AI agent system; and
an output interface to communicate the response of the AI agent system.

16. The artificial intelligence (AI) agent system of claim 15 wherein the data processor is configured to determine the context-aware data from the input data utilizing a multi-layered knowledge graph technique.
